(19) United States
(12) Patent Application Publication
(10) Pub. No.: US 2011/0318963 A1
(43) Pub. Date: Dec. 29, 2011

(54) SHIELD CONNECTOR

(75) Inventors: Daisuke KAMOYA, Osaka-shi (JP); Yoshifumi NISHIDA, Osaka-shi (JP)

(73) Assignee: J.S.T. Mfg. Co., Ltd., Osaka-shi (JP)

(21) Appl. No.: 13/166,596

(22) Filed: Jun. 22, 2011

(30) Foreign Application Priority Data
Jun. 23, 2010 (JP) 2010-142163

(51) Int. Cl. H01R 13/6581

(52) U.S. Cl. 439/607.35

(57) ABSTRACT

A metal shell includes a pair of side face shield walls for respectively covering both side faces of a housing and a coupling shield wall perpendicular to the side face shield walls and coupling the side face shield walls together, and covers the circumference of the housing. A metal slider is movably attached to at least one of the housing and the shell while coming into slidable contact therewith. The slider electrically connects contacts and conductors of a flexible conductive member and is electrically connected to the shell and a shield portion exposed on the surface of the flexible conductive member, in a state where the slider has moved from the rear side toward the front side with respect to the housing.

### CROSS-REFERENCE TO RELATED APPLICATIONS

This application claims priority to Japanese Patent Application No. 2010-142163. The entire disclosure of Japanese Patent Application No. 2010-142163 is hereby incorporated herein by reference.

### BACKGROUND OF THE INVENTION

1. Field of the Invention

The present invention relates to a shield connector that has a shielding function and can be connected to a flexible conductive member configured as a flexible board or a flexible cable including a plurality of insulated conductors.

2. Description of Related Art

Conventional shield connectors are known that have a shielding function and can be connected to a flexible conductive member configured as a flexible board or a flexible cable including a plurality of insulated conductors (see JP 3089464B). The shield connector disclosed in JP 3089464B includes a housing, holddowns, a plurality of contacts, and a slider. An end of the flexible conductive member configured as a flexible cable is disposed on the housing that supports the plurality of contacts. The holddowns are provided on both side faces of the housing, thus fixing the housing onto a circuit board. The slider serving as a pressing member that is movably attached to the housing is configured to electrically connect the flexible conductive member to the contacts and also to electrically connect the shield portion exposed on the surface of the flexible conductive member and the holddowns by coming into contact therewith, when the slider is inserted into the housing.

The shield connector disclosed in JP 3089464B is configured to exhibit its shielding function by the slider electrically connecting the shield portion of the flexible conductive member and the holddowns disposed on both side faces of the housing when the slider is inserted into the housing. The slider is configured to move with respect to the housing from the front side of the housing, which is the side of the housing where the end of the flexible conductive member is disposed, to the rear side, which is the opposite side, and along the direction of insertion of the flexible conductive member into the housing.

As described above, the shield connector disclosed in JP 3089464B exhibits its shielding function as an anti-electromagnetic wave noise measure by electrically connecting the shield portion of the flexible conductive member to the holddowns disposed on both side faces of the housing via the slider. Therefore, the shield connector can exert the effect of the shielding function only in an area where the shield portion of the flexible conductive member is disposed, making it difficult to ensure a sufficient shielding function. Furthermore, it is difficult to ensure a sufficient shielding function on both side faces of the connector only through the holddowns disposed on both side faces of the housing.

In addition, the shield connector disclosed in JP 3089464B is configured to complete an electrical connection to the flexible conductive member by the slider moving (being pushed) with respect to the housing from the front side to the rear side and along the direction of insertion of the flexible conductive member into the housing. Therefore, when the slider is operated to perform a connector connection operation for completing an electrical connection between the flexible conductive member and the shield connector, an operating portion of the slider and the flexible conductive member whose end is disposed in the housing are brought into a state where they are fairly close to each other. This leads to the problem that the fingers of an operator are brought into contact with the flexible conductive member at the time of operation of the slider, making the operation difficult to perform and thus reducing the operability of the slider.

With the shield connector disclosed in JP 3089464B, as described above, the movement direction (pushing direction) of the slider with respect to the housing is a direction from the front side to the rear side of the housing along the direction of insertion of the flexible conductive member into the housing. Therefore, when the end of the flexible conductive member is disposed by being inserted into the housing, the slider becomes an obstacle blocking the field of view of the operator, resulting in the problem of difficulty in placing the end of the flexible conductive member in an appropriate position of the housing.

With the shield connector disclosed in JP 3089464B, operating portions that are each formed as a projection are provided on both sides in the width direction of the slider. When performing an operation (operation of pulling out a slider) for moving the slider so as to pull out the slider to the opposite side to the direction of the connector connection operation from the state where an electrical connection has been once completed, the operator pulls out the slider by simultaneously operating the operating portions on both sides of the slider. Therefore, if the operation timings of the operating portions on both sides fail to coincide, then the slider is forcibly pulled out in such a state where the slider pries into the housing and the like, which leads to deformation and breakage of the slider, the housing, and the like and causes a damage to the shield connector.

### SUMMARY OF THE INVENTION

In view of the forgoing circumstances, it is an object of the present invention to provide a shield connector that can ensure a sufficient shielding function, improve the operability of a slider, facilitate the placement of a flexible conductive member, and prevent damage during an operation of pulling out the slider.

According to a first feature of a shield connector of the present invention for achieving the above-described object, there is provided a shield connector including: a housing formed from a resin material; a plurality of contacts that are supported by the housing and that can be respectively connected to a plurality of insulated conductors of a flexible conductive member configured as a flexible board or a flexible cable; a shell that is formed of a metallic material, and that includes a pair of side face shield walls for respectively covering both side faces of the housing and a coupling shield wall perpendicular to the pair of side face shield walls and coupling the pair of side face shield walls together, and that is attached to the housing so as to cover a circumference of the housing; a slider that is formed of a metallic material, that is movably attached to at least one of the housing and the shell while coming into slidable contact therewith, and that is movable between a front side of the housing, which is the side where an end of the flexible conductive member can be disposed, and a rear side, which is opposite to the front side; and a lead portion that is formed integrally with the shell and that can be fixed by soldering to a substrate configured as at least one of a rigid substrate and a flexible board, wherein the slider electrically connects the contacts and the conductors of the flexible conductive member and is electrically connected to the shell and a shield portion exposed on the surface of the flexible conductive member, in a state where the slider has moved from the rear side toward the front side with respect to the housing.

With this configuration, the shell covering the circumference of the housing is electrically connected to the shield portion of the flexible conductive member via the slider, and the lead portion formed integrally with the shell is fixed to the ground side of the substrate, thus achieving a shielding function. Also, the shell is provided with the pair of side face shield walls respectively covering both side faces of the housing and the coupling shield wall that is perpendicular to the pair of side face shield walls and that couples the pair of side face shield walls together. Accordingly, a sufficient shielding function as an anti-electromagnetic wave noise measure can be ensured for the both side faces of the housing covered by the shell and surfaces perpendicular thereto. In addition, the shell may be also provided with the opposed shield walls disposed so as to be opposed to the coupling shield wall, in addition to the pair of side face shield walls and the coupling shield wall. In this case, it is possible to configure the shell in the form of a rectangular tube, and realize a shell structure that can shield four peripheral surfaces of the housing only by the shell.

With this configuration, the slider moves from the rear side toward the front side with respect to the housing, thus electrically connecting the contacts and the conductors of the flexible conductive member, and being brought into the state of being electrically connected to the shield portion exposed on the flexible conductive member and to the shell. This completes an electrical connection. Accordingly, since the slider is operated to move from the rear side toward the front side with respect to the housing, the operating portion of the slider and the flexible conductive member whose end is disposed in the housing are separately positioned on the sides opposite from each other via the housing, when performing the connector connection operation for completing an electrical connection between the flexible conductive member and the shield connector after operating the slider. This prevents the fingers of the operator and the flexible conductive member from coming into contact to make the operation of the slider difficult, thus improving the operability of the slider.

With this configuration, the slider is attached to at least one of the housing and the shell so as to move from the rear side of the housing toward the front side during operation of the slider. Accordingly, it is possible to prevent the slider from blocking the field of view of the operator when inserting an end of the flexible conductive member to the front side of the housing. This facilitates the placement of the end of the flexible conductive member in an appropriate position of the housing.

With this configuration, the slider is attached to at least one of the housing and the shell so as to move from the rear side of the housing toward the front side during operation, as described above. Accordingly, when the slider is operated to move, the operator can easily operate the slider at an intermediate part of the slider in the width direction or at a portion located near that intermediate part. Accordingly, when the operator performs an operation (operation of pulling out a slider) for moving the slider so as to pull out the slider to the opposite side to the direction of the connector connection operation from the state where an electrical connection has been once completed, it is possible to prevent to a damage to the shield connector as caused in conventional shield connectors. In other words, it is possible to prevent the occurrence of such a condition in which the slider is forcibly pulled out in such a state where the slider pries into the housing and the like due to the operation timings of the plurality of operating portions failing to coincide, thus making it possible to prevent a damage to the shield connector during the operation of pulling out the slider.

Accordingly, with this configuration, it is possible to provide a shield connector that can ensure a sufficient shielding function, can improve the operability of the slider, can facilitate the placement of the flexible conductive member, and can prevent the occurrence of damage during the operation of pulling out the slider.

According to a second feature of a shield connector of the present invention, in the shield connector having the first feature, the housing is provided with an open portion that is opened such that the end of the flexible conductive member can be disposed therein, and the open portion is opened in the housing from the front side to an upper side, which is opposite to the side facing the substrate, exposing the plurality of contacts.

With this configuration, the housing is provided with the open portion that is opened from the front side to the upper side, exposing the plurality of contacts. Since an end of the flexible conductive member can be disposed in the open portion, which is widely opened in this way, it is possible to realize a shield connector that can further facilitate the placement of the flexible conductive member. Further, since the open portion, which is a region where the end of the flexible conductive member is disposed, is widely opened from the front side to the upper side in the housing, it is possible to select the configuration for inserting the end of the flexible conductive member into the housing from various configurations, and therefore the degree of freedom in design as the shield connector can be greatly improved.

According to a third feature of a shield connector of the present invention, in the shield connector having the second feature, the shell is provided, in the coupling shield wall for covering the housing on an upper side, which is opposite to the side where the shell can be installed on the substrate, with a shell-side open portion that is opened, exposing the open portion of the housing.

With this configuration, the coupling shield wall of the shell is provided as a wall portion covering the upper side of the housing, and the shell-side open portion corresponding to the open portion of the housing is opened in the coupling shield wall. Accordingly, during the placement of the end of the flexible conductive member in the open portion of the housing, it is possible to prevent the slider from blocking the field of view of the operator, and also to prevent the shell from blocking the field of view of the operator. This can further facilitate the placement of the end of the flexible conductive member in an appropriate position of the housing.

According to a fourth feature of a shield connector of the present invention, in the shield connector having the second feature, the slider covers at least part of the open portion by moving from the rear side toward the front side with respect to the housing, and covers the open portion, extending beyond portions of contact between the contacts and the conductors of the flexible conductive member from the rear side toward the front side.

With this configuration, the slider moves from the rear side to the front side during the connector connection operation, thereby covering the open portion so as to cover at least the portions of contact between the contacts and the conductors of the flexible conductive member. Accordingly, at least a region in the vicinity of the portions of contact between the contacts and the conductors of the flexible conductive member is shielded in the open portion by the slider. Thus, when disposing the end of the flexible conductive member in the housing, the flexible conductive member can be easily disposed in the open portion, and it is also possible to achieve a shield connector that can appropriately shield the open portion by the slider in a state where an electrical connection has been completed.

According to a fifth feature of a shield connector of the present invention, in the shield connector having the first feature, the slider is attached to at least one of the housing and the shell, being electrically connected to the shell also in a state before the slider moves from the rear side toward the front side with respect to the housing.

According to the invention, the slider is configured to be electrically connected to the shell both in states before and after operating the slider for the connector connection operation. Accordingly, the slider is electrically connected to the shell constantly also in a state before the connector connection operation, thus preventing accumulation of static electricity, and further enhancing the shielding function.

According to a sixth feature of a shield connector of the present invention, in the shield connector having the first feature, a rear surface wall is provided that is formed in at least one of the shell and the slider and that can cover a surface of the housing on the rear side.

The shield connector disclosed in JP 3089464B cannot shield the rear side of the housing. However, with this configuration, at least one of the shell and the slider is provided with the rear surface wall covering the rear side surface of the housing, and therefore it is possible to shield the rear side of the housing, and further enhance the shielding function. Further, the rear surface wall is disposed on the side opposite to the front side of the housing, which is the side where the end of the flexible conductive member is disposed and the flexible conductive member is drawn out. Accordingly, it is possible to easily install the rear surface wall without affecting the placement of the flexible conductive member.

According to a seventh feature of a shield connector of the present invention, in the shield connector having the first feature, at least one of the slider and the shell is provided with a protrusion that is formed protruding in a raised manner, and the slider and the shell are electrically connected via the protrusion.

With this configuration, it is possible to easily achieve a structure that can reliably ensure an electrical connection between the slider and the shell for exerting the shielding function with a simple configuration in which at least one of the slider and the shell is provided with the protrusion that is formed in a raised manner.

According to an eighth feature of a shield connector of the present invention, in the shield connector having the first feature, the slider and the shell are provided with first locking portions formed as raised portions coming into locking engagement with each other in a state before the slider moves from the rear side toward the front side with respect to the housing, and second locking portions formed as raised portions coming into locking engagement with each other in a state after the slider has moved from the rear side toward the front side with respect to the housing.

With this configuration, the first locking portions and the second locking portions coming into locking engagement in states of before and after operating the slider for the connector connection operation are provided as raised portions in the slider and the shell. Accordingly, when the operation for bringing the shell and the slider into locking engagement in the first locking portions is performed, the feeling of a click (the feeling of vibrations transmitted to the fingers resulting from an instantaneous elastic recovery at the first locking portions) is generated by that operation, and therefore the operator can easily confirm that the shell has come into locking engagement with the slider in a state before the connector connection operation. When the operation for bringing the shell and the slider into locking engagement in the second locking portions is performed, the feeling of a click (the feeling of vibrations transmitted to the fingers resulting from an instantaneous elastic recovery at the second locking portions) is generated by that operation, and therefore the operator can easily confirm that the connector connection operation has been completed.

According to a ninth feature of a shield connector of the present invention, in the shield connector having the first feature, guide grooves for guiding in a direction in which the end of the flexible conductive member is inserted are formed in the housing.

With this configuration, when an end of the flexible conductive member is inserted into the housing, the end of the flexible conductive member is guided to a predetermined position along the guide grooves formed in the housing. This can further facilitate the placement of the flexible conductive member in an appropriate position relative to the housing.

According to a tenth feature of a shield connector of the present invention, in the shield connector having the ninth feature, the end of the flexible conductive member is provided with projecting piece portions that are formed respectively protruding toward both lateral sides in opposite directions in a width direction, which is the direction in which the plurality of conductors are disposed, and that can be inserted into the guide groove, and the projecting piece portions engage with the housing toward the front side in a state where the end of the flexible conductive member is disposed in the housing.

With this configuration, the end of the flexible conductive member that can be disposed in the housing is provided with the projecting piece portions that protrude to both lateral sides on opposite sides in the width direction. When the end of the flexible conductive member is inserted into the housing, the end of the flexible conductive member is guided to a predetermined position by the projecting piece portions along the guide grooves of the housing. Further, upon reaching an appropriate position of the housing, the end of the flexible conductive member engages with the housing in the projecting piece portions toward the front side. Accordingly, if the slider is operated to move from the rear side toward the front side in a state where the end of the flexible conductive member is disposed in the housing, it is possible to prevent the flexible conductive member from being detached from the housing to the front side due to a frictional force exerted from the slider.

It should be appreciated that the above and other objects, and features and advantages of the present invention will become apparent from the following description taken in conjunction with the accompanying drawings.

### BRIEF DESCRIPTION OF THE DRAWINGS

FIG. 1A is a perspective view showing a shield connector according to an embodiment of the present invention.

FIG. 1B is a perspective view of the shield connector shown in FIG. 1A, as viewed from a different angle from FIG. 1A.

FIG. 2 is an exploded perspective view of the shield connector shown in FIG. 1A.

FIG. 3 is a perspective view showing a state where a flexible conductive member is disposed in the shield connector shown in FIG. 1A.

FIG. 4 is a perspective view showing a state where an electrical connection between the shield connector shown in FIG. 1A and the flexible conductive member is completed.

FIG. 5A is a perspective view showing a flexible conductive member for being connected to the shield connector shown in FIG. 1A, including a cutaway section.

FIG. 5B is a perspective view showing a flexible conductive member according to a modification, including a cutaway section.

FIG. 6 is a cross-sectional view showing a cross section of the end of the flexible conductive member shown in FIG. 5A in the longitudinal direction.

FIG. 7 is a perspective view showing a housing of the shield connector shown in FIG. 1A.

FIG. 8A is a plan view of the shield connector shown in FIG. 1A.

FIG. 8B is a cross-sectional view showing a cross section as viewed from the position of the arrows A-A in FIG. 8A.

FIG. 9A is a cross-sectional view as viewed from the position of the arrows A-A in FIG. 8A, showing a state where the flexible conductive member is being disposed in the housing.

FIG. 9B is a cross-sectional view as viewed from the position of the arrows A-A in FIG. 8A, showing a state where the flexible conductive member has been disposed in the housing.

FIG. 10 is a perspective view showing a shell of the shield connector shown in FIG. 1A.

FIG. 11 is a perspective view showing a slider of the shield connector shown in FIG. 1A.

FIG. 12A is a plan view showing a state where the slider has moved to the front side with respect to the housing in the shield connector shown in FIG. 1A.

FIG. 12B is a cross-sectional view as viewed from the position of the arrows B-B in FIG. 12A.

FIG. 13A is a perspective view of the shield connector shown in FIG. 12A.

FIG. 13B is a perspective view of the shield connector shown in FIG. 13A, as viewed from a different angle from FIG. 13A.

FIG. 13C is a perspective view of the shield connector shown in FIG. 13A, as viewed from a different angle from FIG. 13A.

FIG. 14 is a cross-sectional view showing the flexible conductive member and the shield connector shown in FIG. 4.

FIG. 15A is a cross-sectional view as viewed from the position of the arrows C-C in FIG. 15B.

FIG. 15B is a plan view of the shield connector shown in FIG. 1A.

FIG. 15C is a cross-sectional view as viewed from the position of the arrows D-D in FIG. 15B.

FIG. 16A is a cross-sectional view as viewed from the position of the arrows E-E in FIG. 16B.

FIG. 16B is a plan view of the shield connector shown in FIG. 12A.

FIG. 16C is a cross-sectional view as viewed from the position of the arrows F-F in FIG. 16B.

FIG. 17A is a plan view of a shield connector according to a modification.

FIG. 17B is a cross-sectional view as viewed from the position of the arrows G-G in FIG. 17A.

FIG. 18A is a plan view of a shield connector according to a modification.

FIG. 18B is a cross-sectional view as viewed from the position of the arrows H-H in FIG. 18A.

FIG. 19A is a plan view of a shield connector according to a modification.

FIG. 19B is a cross-sectional view as viewed from the position of the arrows I-I in FIG. 19A.

FIG. 20A is a plan view of a shield connector according to a modification.

FIG. 20B is a cross-sectional view as viewed from the position of the arrows J-J in FIG. 20A.

### DETAILED DESCRIPTION OF THE INVENTION

Hereinafter, an embodiment for carrying out the present invention will be described with reference to the accompanying drawings. It should be appreciated that the present invention can be widely applied to various uses as a shield connector that has a shielding function and can be connected to a flexible conductive member configured as a flexible board or a flexible cable including a plurality of insulated conductors.

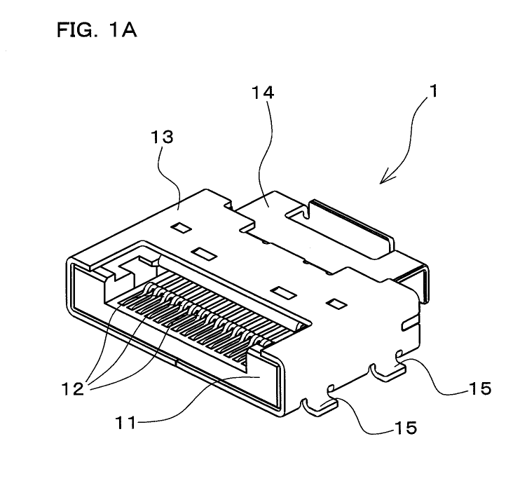

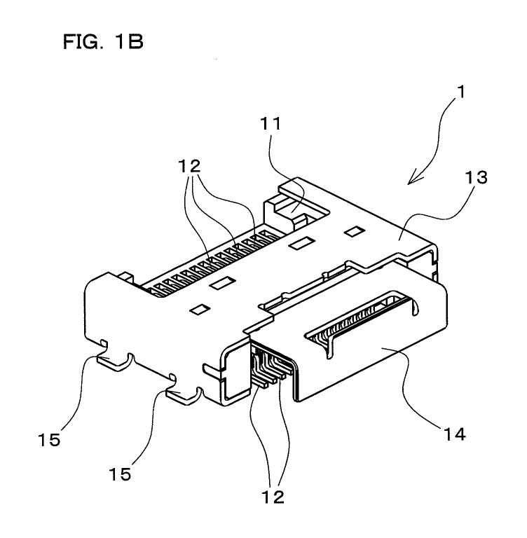

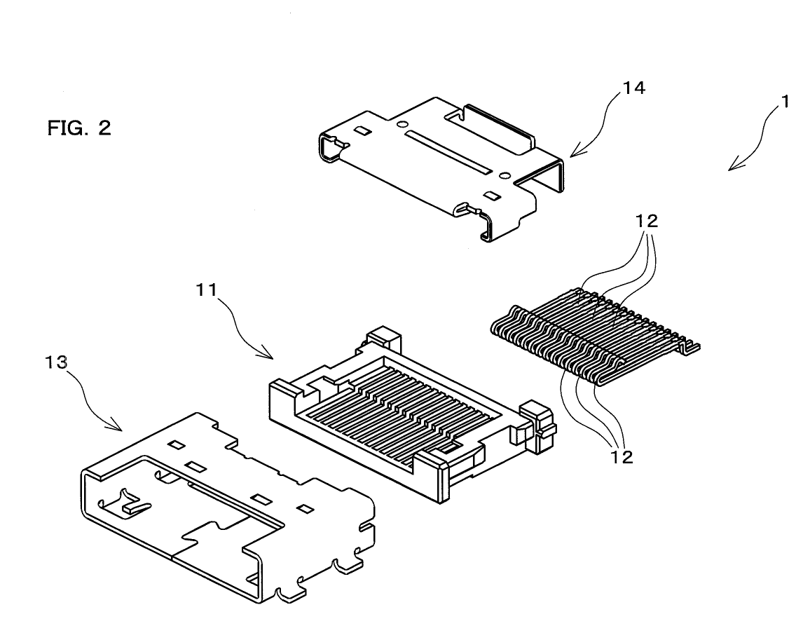

FIG. 1 (FIGS. 1A, 1B) are perspective views showing a shield connector 1 according to one embodiment of the present invention. FIG. 1A and FIG. 1B are perspective views of the shield connector 1 as viewed from different angles. FIG. 2 is an exploded perspective view of the shield connector 1. As shown in FIGS. 1 and 2, the shield connector 1 includes a housing 11, a plurality of contacts 12, a shell 13, a slider 14, and lead portions 15.

To assemble the shield connector 1, first, the plurality of contacts 12 are disposed and supported on the inside of the housing 11. At this time, the plurality of contacts 12 are coupled at their ends so as to be easily handled as an integral unit. Then, with the integrally coupled plurality of contacts 12 being supported on the housing 11, the portion (not shown) where the ends of the plurality of contacts 12 are coupled together is separated and removed. Consequently, the plurality of contacts 12 are supported on the housing 11 in the state where they are separated from each other.

After the plurality of contacts 12 have been supported with respect to the housing 11, the slider 14 is attached to the housing 11 in that state. Then, the tubular shell 13 is attached to the housing 11, to which the slider 14 has been mounted, such that the housing 11 is inserted into the shell 13 from outside the shell 13. Thereby, the shield connector 1 is brought into a state as shown in FIG. 1.

The shield connector 1 that has been assembled into the state shown in FIG. 1 can be fixed by soldering to a substrate, which is not shown, at a plurality of lead portions 15 that are integrally formed with the shell 13 and protrude in the shape of small legs. Thereby, the shield connector 1 is fixed to the substrate, and is electrically connected to the ground side of the substrate. Note that this embodiment illustrates a configuration in which the lead portions 15 protrude from the shell 13 at four locations. The above-noted substrate is configured as at least one of a rigid substrate and a flexible board.

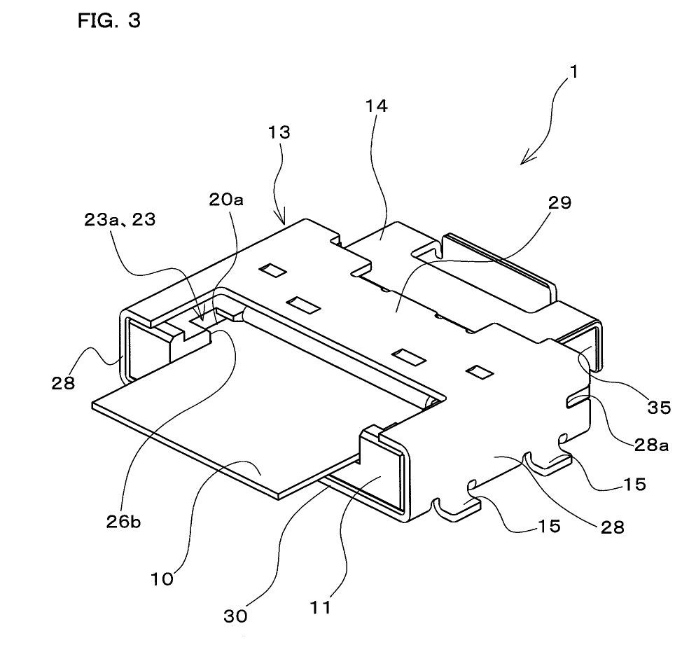

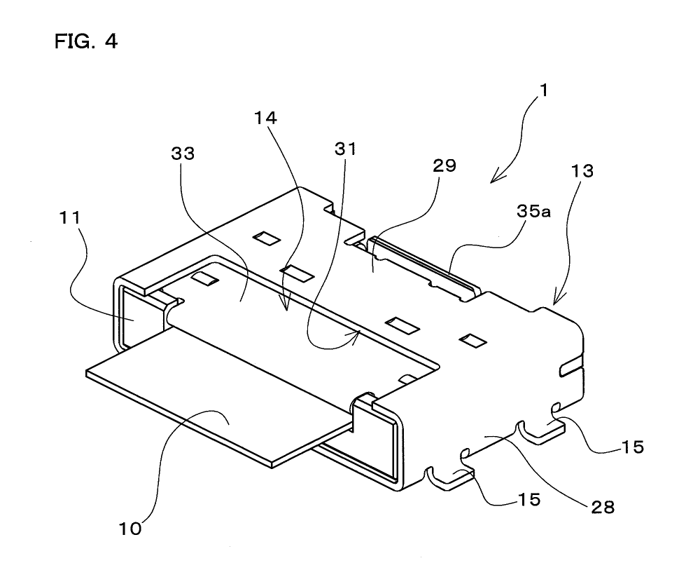

FIG. 3 is a perspective view showing a state where a flexible conductive member 10 is disposed in the shield connector 1 that has been assembled as shown in FIG. 1. As shown in FIG. 3, when performing a connector connection operation for completing an electrical connection between the flexible conductive member 10 and the shield connector 1, first, an end of the flexible conductive member 10 is disposed in a predetermined position of the housing 11 of the shield connector 1. Note that in FIG. 3, the end (the end drawn out from the housing 11) of the flexible conductive member 10 that is opposite to the end disposed in the housing 11 is shown in a cutaway section (the same applies to FIG. 4 described below).

FIG. 4 is a perspective view showing a state where the above-mentioned connector connection operation has been completed, thus completing an electrical connection between the flexible conductive member 10 and the shield connector 1. After the end of the flexible conductive member 10 has been disposed in the housing 11 (see FIG. 3), the slider 14 is then operated in the manner described below, and thereby the connector connection operation is finished. Consequently, both electrical connection and mechanical connection between the flexible conductive member 10 and the shield connector 1 are completed. In the following, various components of the flexible conductive member 10 and the shield connector 1 will be described in further detail.

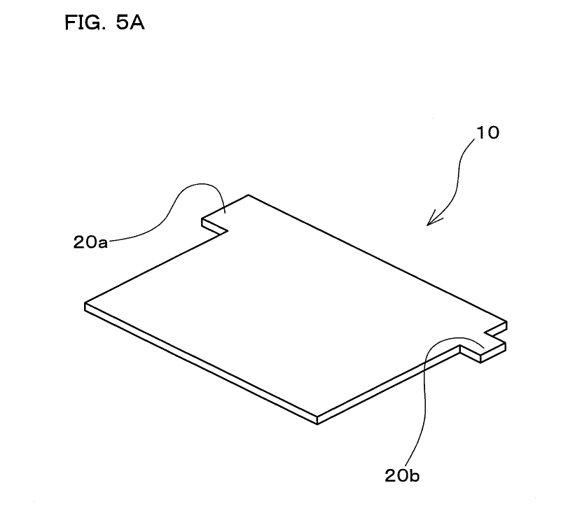

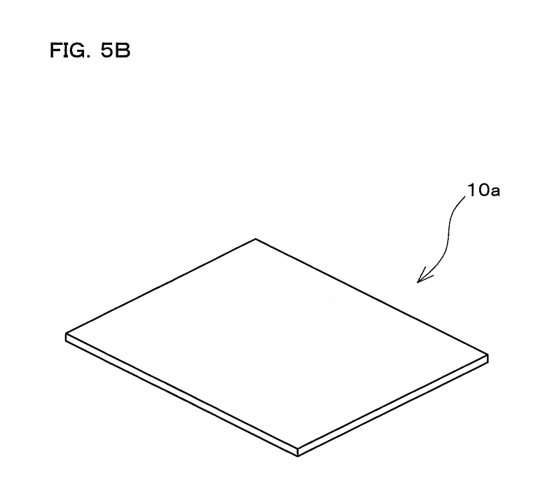

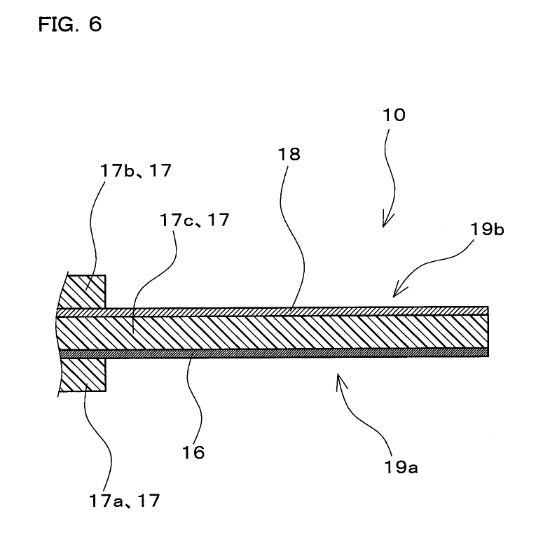

FIG. 5 shows a perspective view of the flexible conductive member 10 that can be connected to the shield connector 1 (FIG. 5A) and a perspective view of a flexible conductive member 10a according to a modification (FIG. 5B), each including a cutaway section. FIG. 6 is a cross-sectional view showing a cross section of an end of the flexible conductive member 10 in the longitudinal direction. The flexible conductive member 10 shown in FIGS. 5A and 6 is configured as a flexible printed circuit board (FPC) serving as a flexible board in this embodiment. The flexible conductive member 10 includes a plurality of linear conductors 16 that are insulated by a covering portion 17 made of an insulating material and aligned parallel to each other, and a shield portion 18 that exerts a shielding function as an anti-electromagnetic wave noise measure. Each of the linear conductors 16 may be formed, for example, as a single metal wire rod or as an assembly of bundled fine wire rods. The shield portion 18 is formed of a metallic material in the shape of a foil.

The covering portion 17 is formed in a three-layer structure, and includes a covering portion 17a disposed on one surface of the flexible conductive member 10, a covering portion 17b disposed on the other surface, and a covering portion 17c disposed in between. The covering portion 17a and the covering portion 17c are disposed so as to sandwich the plurality of conductors 16 disposed parallel to each other, from both sides (that is, the plurality of conductors 16 are disposed between the covering portion 17a and 17c). The covering portion 17b and the covering portion 17c are disposed so as to sandwich the shield portion 18 in the form of a metallic foil from both sides (that is, the shield portion 18 is disposed between the covering portion 17b and the covering portion 17c). Thus, the flexible conductive member 10 is configured as a flexible printed circuit board in which the covering portion 17 (17a, 17b, 17c), the plurality of conductors 16, and the shield portion 18 form a layer structure. Furthermore, as shown in FIG. 6, the covering portion 17a and the covering portion 17b disposed on both surfaces are partly removed at the end of the flexible conductive member 10. Accordingly, a conductor-exposed portion 19a, where the plurality of conductors 16 are exposed on the surface as a result of the insulated covering portion 17a having been partly removed, is formed on one surface of the end of the flexible conductive member 10. Further, a shield portion-exposed portion 19b, where the shield portion 18 is exposed on the surface as a result of the insulated covering portion 17b having been partly removed, is formed on the other surface of the end of the flexible conductive member 10. The conductor-exposed portion 19a and the shield portion-exposed portion 19b may be formed, for example, by uncovering the covering portion 17a and the covering portion 17b along the longitudinal direction of the flexible conductive member 10 (that is, the extension direction in which the plurality of conductors 16 extend parallel to each other) at the end of the flexible conductive member 10.

Furthermore, as shown in FIG. 5A, a pair of projecting piece portions (20a, 20b) that are formed protruding toward both lateral sides, respectively, are provided at the end of the flexible conductive member 10 on opposite sides in the width direction in which the plurality of conductors 16 are disposed. These projecting piece portions (20a, 20b) are provided as portions that can be inserted into guide grooves 23, which will be described later, of the housing 11, are formed of an insulating material, and are provided integrally with the covering portion 17. One of the projecting piece portions, namely, the projecting piece portion 20a, and the other of the projecting piece portions, namely, the projecting piece portion 20b are formed such that they are different from each other in the position and the shape, and are provided protruding at positions that are displaced from each other in the longitudinal direction of the flexible conductive member 10. The guide grooves 23 that are respectively formed in inner two side walls of the housing 11 are provided such that the positions of the grooves in the innermost wall portion are different from each other in correspondence with the projecting piece portion 20a and the projecting piece portion 20b, respectively. This provides a configuration that can prevent the flexible conductive member 10 from being disposed in the shield connector 1 upside-down and being erroneously connected.

It is also possible to use a flexible conductive member 10a in which the projecting piece portions (20a, 20b) are not provided, as a modification as shown in FIG. 5B. Although this embodiment shows that the flexible conductive member to which the shield connector 1 is connected is configured as a flexible printed circuit board, this need not be the case. That is, the flexible conductive member to which the shield connector 1 is connected is not limited to the flexible printed circuit board having the above-described configuration, and may be any flexible conductive member including a shield portion and a plurality of insulated conductors. For example, a flexible printed circuit board having a layer structure and a conductor arrangement structure that are different from those of the above-described configuration may be used as the flexible conductive member. A flexible board formed in a configuration other than a flexible printed circuit board may also be used as the flexible conductive member. A flexible cable such as a flexible flat cable (FFC) may also be used as the flexible conductive member.

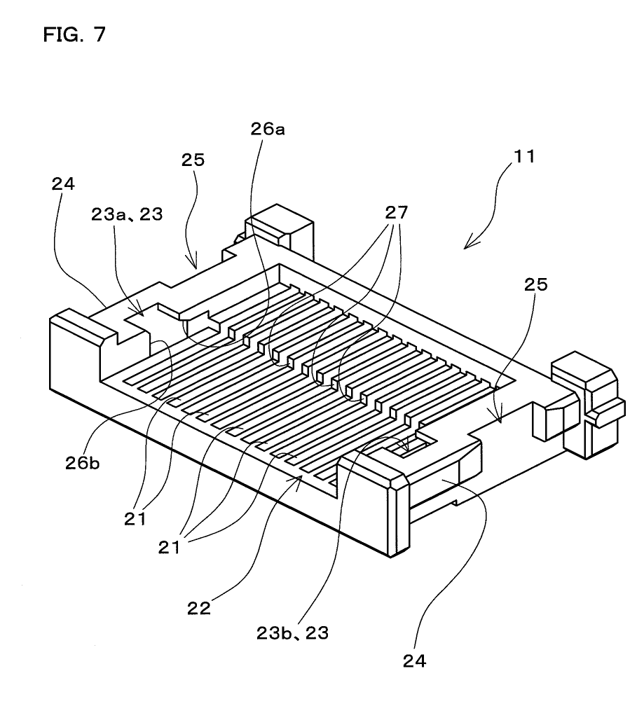

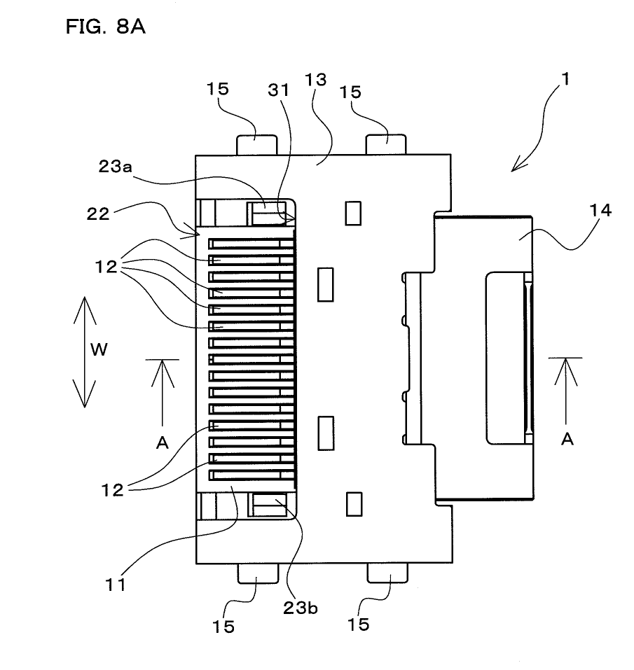

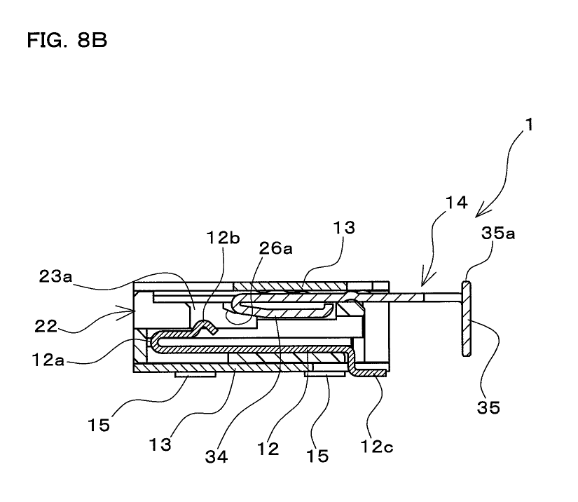

FIG. 7 is a perspective view of the housing 11. FIG. 8 are diagrams showing a plan view of the shield connector 1 in the state shown in FIG. 1 (FIG. 8A), and a cross-sectional view showing a cross section as viewed from the position of the arrows A-A in FIG. 8A (FIG. 8B). The housing 11 is formed from a resin material serving as an insulating material, and is provided as a thin, substantially rectangular solid member. For example, materials such as LCP (Liquid Crystal Polymer) and PA (polyamide) may be used as the resin material for forming the housing 11. Also, the housing 11 is provided with a plurality of contact support grooves 21, an open portion 22, the guide grooves 23, slider locking portions 24, recesses 25, and so forth. Note that the guide grooves 23, the slider locking portions 24, and the recesses 25 are provided in pairs.

The plurality of contact support grooves 21 are formed as grooves in which the plurality of contacts 12 are respectively disposed. The contact support grooves 21 are aligned along the width direction of the housing 11, and are formed extending parallel to each other. The plurality of contacts 12 are supported with respect to the housing 11 by the contacts 12 being fitted to the contact support grooves 21. In FIG. 8A, the width direction of the housing 11 is indicated by the double-ended arrow W. The width direction of the housing 11 is the same as the width direction of the shield connector 1, the width direction of the shell 13, and the width direction of the slider 14.

The open portion 22 is formed as a central part that is opened so as to form a wide recess in the housing 11, and is provided as a portion that is opened such that an end of the flexible conductive member 10 can be disposed therein. Also, the open portion 22 is opened in the housing 11 so as to expose the plurality of contacts 12 from the front side, which is the side where the end of the flexible conductive member 10 is disposed, to the upper side, which is the side opposite to the side facing the substrate (not shown) to which the lead portions 15 are fixed by soldering. The flexible conductive member 10 whose end is disposed in the open portion 22 is disposed in the housing 11 so as to be pulled out from the front side to the outside (see FIG. 3).

The guide grooves 23 are configured as a guide groove 23a and a guide groove 23b that are respectively formed in the width direction on the inner side of opposing side walls of the housing 11. The guide grooves 23 (23a, 23b) are formed as groove portions for guiding in the direction in which the end of the flexible conductive member 10 is inserted. One of the guide grooves, namely, the guide groove 23a corresponds to one of the projecting piece portions, namely, the projecting piece portion 20a at the end of the flexible conductive member 10 (see FIG. 3), the other of the guide grooves, namely, the guide groove 23b corresponds to the other of projecting piece portions, namely, the projecting piece portion 20b. When disposing the end of the flexible conductive member 10 in the open portion 22 of the housing 11, the projecting piece portion 20a is inserted into the guide groove 23a, the projecting piece portion 20b is inserted into the guide groove 23b, and the flexible conductive member 10 is inserted until the projecting piece portions (20a, 20b) come into contact with the innermost wall portions of the respective guide grooves (23a, 23b).

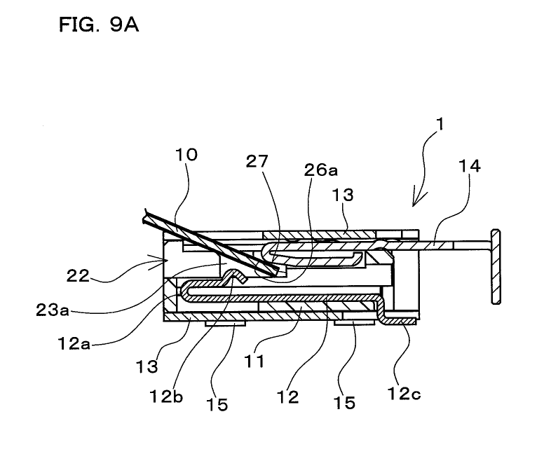

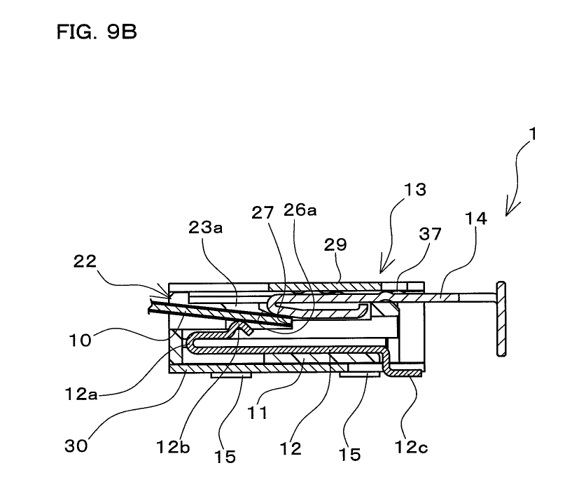

FIG. 9A is a cross-sectional view as viewed from the position of the arrows A-A in FIG. 8A, showing a state where the flexible conductive member 10 is being disposed in the open portion 22. FIG. 9B is a cross-sectional view as viewed from the position of the arrows A-A in FIG. 8A, showing a state where the flexible conductive member 10 has been disposed in the open portion 22. As is clearly shown in FIGS. 7, 8B, 9A, and 9B, the housing 11 is provided, on the upper side of each of the guide grooves (23a, 23b), with an inclined wall portion 26a that is obliquely inclined from the upper side toward the lower side. When the projecting piece portions (20a, 20b) at the end of the flexible conductive member 10 are inserted into the guide grooves (23a, 23b), the projecting piece portions (20a, 20b) are guided to the innermost side (the rear side) of the guide grooves (23a, 23b) while coming into slidable contact with the inclined wall portions 26a (see FIG. 9A).

Additionally, the housing 11 is provided, in a portion where the open portion 22 is formed, with stepped portions 27 that are provided with a step-like level difference. The housing 11 is configured such that when the projecting piece portions (20a, 20b) are inserted into the guide grooves (23a, 23b), the projecting piece portions (20a, 20b) come into contact with the innermost (rear) wall portions of the guide grooves (23a, 23b) and that the tip end side of the end of the flexible conductive member 10 comes into contact with the stepped portions 27 across the width direction. Accordingly, the shield connector 1 is configured such that the end of the flexible conductive member 10 can be very easily positioned with respect to the housing 11 in an appropriate position. Further, the housing 11 is provided with vertically extending engaging wall portions 26b as the front wall portions of the guide grooves (23a, 23b) (see FIGS. 3 and 7). The projecting piece portions (20a, 20b) are configured to come into contact with the engaging wall portions 26b toward the front side with respect to the housing 11 in a state where the end of the flexible conductive member 10 is disposed in an appropriate position of the housing 11.

The slider locking portions 24 are formed in opposite side walls of the housing 11 in the width direction, and provided as a pair of portions each protruding outward in rail-like form. At the slider locking portions 24, the slider 14, which will be described later, comes into locking engagement with the housing 11. Then, the slider 14 is movably attached to the housing 11 while coming into slidable contact with the housing 11. Further, the recesses 25 are formed on the outside of the opposite side walls of the housing 11 in the width direction, respectively, and are provided as a pair of portions each recessed toward the inside. When attaching the slider 14 to the housing 11, housing locking portions 36, which will be described later, serving as portions of the slider 14 coming into locking engagement with the slider locking portions 24 are inserted into the recesses 25.

The plurality of contacts 12 shown in FIGS. 1, 2, 8, and 9 are each formed of a metallic material (for example, phosphor bronze) serving as a conductive material, and are supported with respect to the housing 11 in the plurality of contact support grooves 21, respectively, as described above. Also, by the end of the flexible conductive member 10 being disposed in the open portion 22, the plurality of contacts 12 come into contact with and thus are electrically connected to the plurality of conductors 16 exposed at the conductor-exposed portion 19a of the end of the flexible conductive member 10.

As is clearly shown in FIGS. 8 and 9, each of the contacts 12 is formed by bending a member in the form of, for example, a long and narrow needle, a rod, or a column. Also, each of the contacts 12 is provided with a spring portion 12a, a contact portion 12b, a connection portion 12c, and so forth.

The spring portion 12a includes a semicircular-arc portion that is bent over about 180 degrees, and is provided as a portion having flexibility by elastic deformation. The elastic force exerted by the spring portion 12a causes the contact portion 12b to be pushed against the conductor 16 of the flexible conductive member 10. Note that since the spring portion 12a includes a semicircular-arc portion that is bent over about 180 degrees as described above, the spring length can easily be set to be long in a compact space, thus making it possible to easily realize a structure that can easily ensure elastic force and increase the degree of freedom of the design for setting the elastic force. Moreover, it is possible to realize a reduction in the thickness of the shield connector 1.

The contact portion 12b is formed as a protruding portion that is bent in a circular arc at the tip end portion of each of the contacts 12, and is provided as a portion that can be electrically connected to each of the conductors 16 of the flexible conductive member 10. Note that the contact portions 12b are disposed protruding from the contact support grooves 21 to the upper side such that they can be connected to the conductors 16 at the end of the flexible conductive member 10 disposed in the open portion 22. The connection portions 12c are provided as portions that can be electrically connected to predetermined conductive portions (not shown), respectively, of the substrate on which the shield connector 1 is installed.

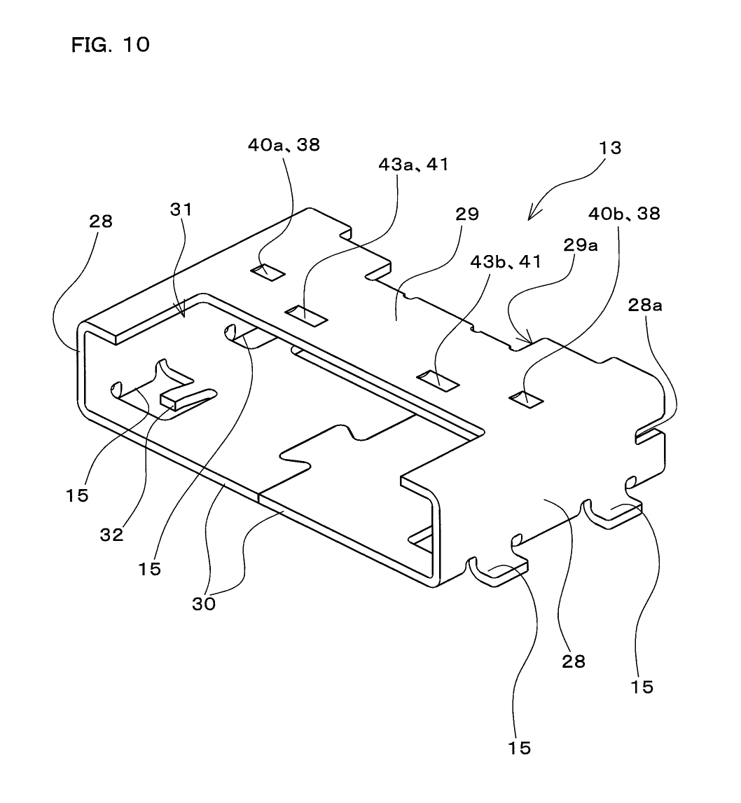

FIG. 10 is a perspective view of the shell 13. The shell 13 shown in FIGS. 1 to 4, and 8 to 10 is formed of a metallic material (for example, phosphor bronze) serving as a conductive material, and is formed as a substantially rectangular tube by performing a bending process or the like, for example, for an integrally formed plate member. The shell 13 is provided with a pair of side face shield walls (28, 28), a coupling shield wall 29, the opposed shield walls 30, a shell-side open portion 31, and so forth. Also, the shell 13 is attached to the housing 11 so as to cover the circumference of the housing 11 (see FIGS. 3 and 10).

The pair of side face shield walls (28, 28) are provided as wall portions that are disposed parallel to each other so as to respectively cover both side faces of the housing 11 in the shell 13 and that have a shielding function. A plurality of (in this embodiment, two) lead portions 15 are formed protruding from the lower end side (the side that is to be disposed on the substrate (not shown)) of each of the side face shield walls 28. In addition, an engaging groove 28a is formed in each of the pair of side face shield walls (28, 28) (see FIGS. 3 and 10). When attaching the shell 13 to the housing 11, the engaging grooves 28a are respectively engaged with the projections provided in the housing 11, thereby performing positioning of the shell 13 with respect to the housing 11 in the front-rear direction.

The coupling shield wall 29 is provided as a wall portion that is perpendicular to the pair of side face shield walls (28, 28), that couples the pair of side face shield walls (28, 28) together, and has a shielding function. The coupling shield wall 29 is configured to cover the housing 11 on the upper side, which is opposite to the side that is to be disposed on the substrate (not shown). Further, the coupling shield wall 29 disposed on the upper side is provided with the shell-side open portion 31 that is opened so as to expose the open portion 22 of the housing 11. The shell-side open portion 31 is opened so as to be widely cut out across the width direction of the shell 13 such that the plurality of contacts 12 supported by the plurality of contact support grooves 21 are exposed in the open portion 22 of the housing 11.

The opposed shield walls 30 are provided as wall portions that are disposed so as to be opposed to the coupling shield wall 29 and that have a shielding function. The shell 13 is installed in a state where it is opposed to the substrate (not shown) at the opposed shield walls 30. The opposed shield walls 30 are configured by fixing a wall portion integrally continuous with one of the two side face shield walls (28, 28) and a wall portion integrally continuous with the other of the two side face shield walls (28, 28) by combining these wall portions at their ends. As such, the shell 13 is configured by the pair of side face shield walls (28, 28), the coupling shield wall 29, and the opposed shield walls 30, which are integrally formed, and is formed into the shape of a substantially rectangular tube. Also, the shell 13 is formed such that its opposite ends in the front-rear direction are open.

In addition, the opposed shield walls 30 are provided with a plurality of housing engaging portions 32 that obliquely protrude toward the upper side (that is, toward the housing 11 side) and that are formed in a cantilevered manner (see FIG. 10). The housing engaging portions 32 are configured to temporarily flex toward the lower side by elastic deformation and then protrude toward the upper side (the housing 11 side) by elastically recovering their original shapes, when attaching the shell 13 to the housing 11 such that the shell 13 is fitted along the periphery of the housing 11 to which the slider 14 has been attached. This provides a configuration that prevents detachment of the housing 11 from the shell 13 that could be caused by the housing engaging portions 32 being fitted into and thus engaging with portions that are recessed in predetermined locations of the housing 11.

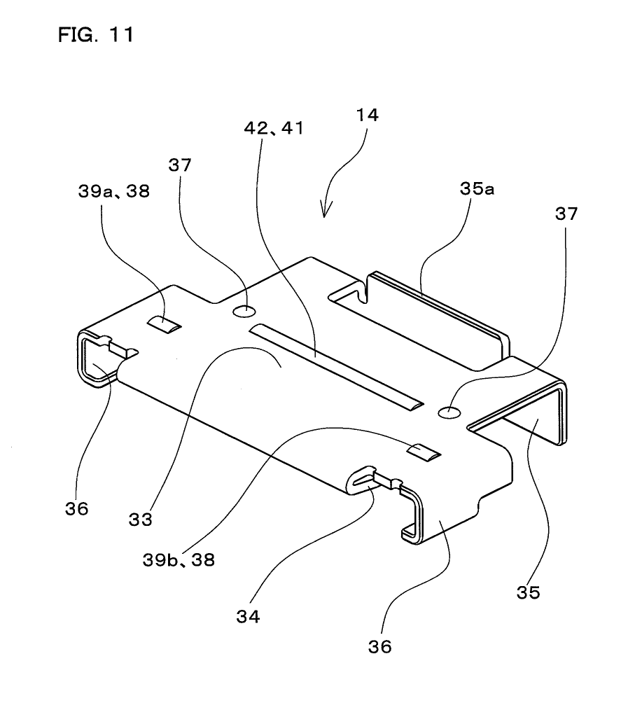

FIG. 11 is a perspective view of the slider 14. The slider 14 shown in FIGS. 1 to 4, and FIGS. 8 to 11 is formed of a metallic material (for example, stainless steel) serving as a conductive material, and is formed by performing a bending process or the like, for example, for an integrally formed plate member. The slider 14 is provided with a flat portion 33, a shield connection portion 34, a rear surface wall 35, housing locking portions 36, protrusions 37, and so forth, and is configured to be movably attached to the housing 11 while coming into slidable contact with the housing 11.

The flat portion 33 is provided as a planar portion, and the shield connection portion 34, the rear surface wall 35, the housing locking portions 36, the protrusions 37, and so forth are integrally formed with the flat portion 33. The flat portion 33 is disposed between the top face side of the housing 11 and the bottom face side of the coupling shield wall 29 of the shell 13 (see FIGS. 3, 4, 8, and 9). The housing locking portions 36 are provided in pair on opposite sides of the flat portion 33 in the width direction (that is, the width direction of the shell 13), and are provided as portions that are bent so as to slidably fit into the slider locking portions 24, respectively, of the housing 11 and are locked to the slider locking portions 24.

When attaching the slider 14 to the housing 11, the housing locking portions 36 are inserted into the recesses 25 of the housing 11 from the upper side. Then, by moving the slider 14 to the front side with respect to the housing 11, the housing locking portions 36 come into locking engagement with the slider locking portions 24 so as to be fitted into the slider locking portions 24. The slider 14 can be slidably locked to the housing 11 at the slider locking portions 24 of the housing locking portions 36, and thus is configured to be movable between the front side of the housing 11 and the rear side, which is the opposite side of the front side, along a linear path in the front-rear direction.

Although this embodiment illustrates a configuration in which the slider 14 is configured to be movable with respect to the housing 11 along a linear path in the front-rear direction, this need not be the case. The slider 14 may be configured to be movable with respect to the housing 11 along a linear path in a direction oblique to the front-rear direction. The slider 14 may also be configured to be movable with respect to the housing 11 along a curvilinear path. The slider 14 may also be configured to be movable with respect to the housing 11 with rotational movement.

The rear surface wall 35 is formed by being bent perpendicularly to the flat portion 33 disposed parallel to the coupling shield wall 29 of the shell 13 in the slider 14. Also, the rear surface wall 35 is provided as a wall portion that covers the rear side face of the housing 11 and that has a shielding function. Further, at the central part of the upper end side of the rear surface wall 35 in the width direction (the width direction of the slider 14), an operating portion 35a that protrudes upward in a state where it is elongated in the width direction is provided. An operator who performs the connector connection operation can perform a movement operation for moving the slider 14 with respect to the housing 11 by operating the operating portion 35a that is provided as a large area at the central part of the slider 14.

The shield connection portion 34 is provided as a portion that is formed by bending a front side part of the flat portion 33 on the front side of the flat portion 33, and is disposed so as to be elongated in the width direction of the slider 14. Further, the shield connection portion 34 has flexibility by elastic deformation, and constitutes a leaf spring-like portion. Also, the shield connection portion 34 is configured to come into contact with the shield portion 18 exposed at the shield portion-exposed portion 19b at the end of the flexible conductive member 10 and to press the flexible conductive member 10 toward the contact portions 12b of the plurality of contacts 12, in a state where the end of the flexible conductive member 10 has been disposed in the housing 11 and the slider 14 has been moved from the rear side toward the front side with respect to the housing 11. Accordingly, the slider 14 is configured to electrically connect the contact portions 12b of the contacts 12 and the conductors 16 of the flexible conductive member 10 and also to be electrically connected to the shield portion 18 exposed on the surface of the flexible conductive member 10, in a state where the slider 14 has moved from the rear side toward the front side with respect to the housing 11. Note that since the shield connection portion 34 includes a portion that is bent on the front side of the flat portion 33 as described above, the spring length can easily be set to be long in a compact space, thus making it possible to easily realize a structure that can easily ensure elastic force and increase the degree of freedom of the design for setting the elastic force. Moreover, it is possible to realize a reduction in the thickness of the shield connector 1.

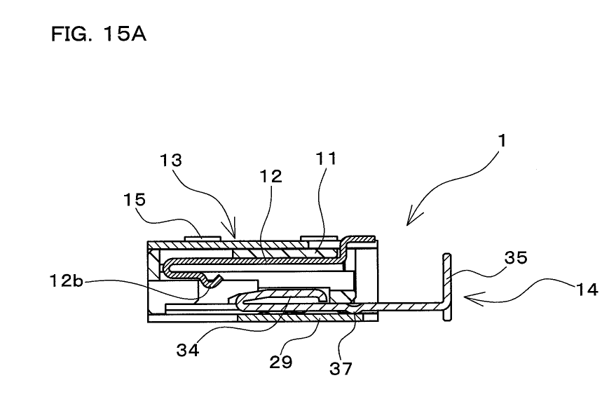

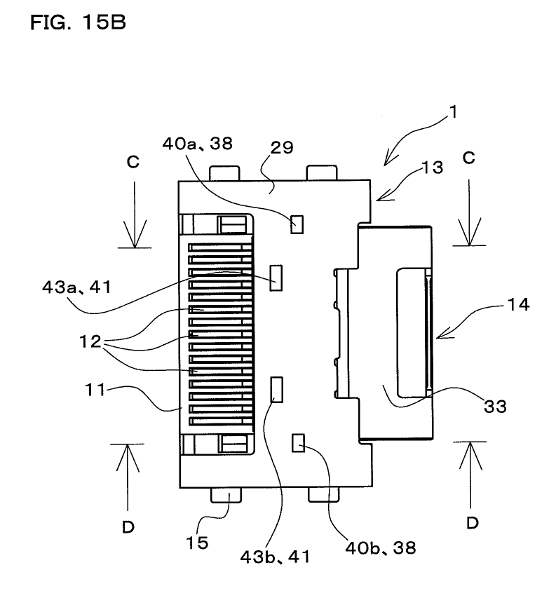

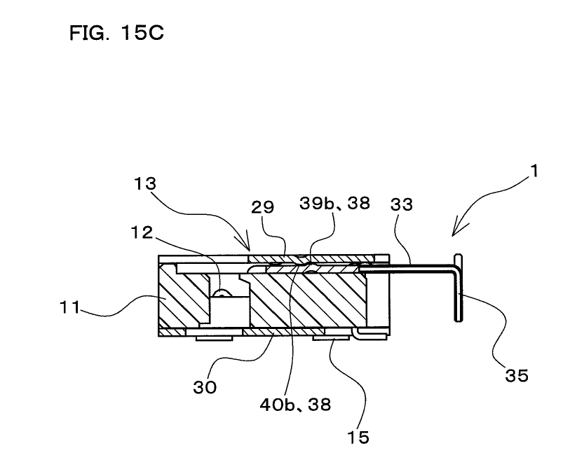

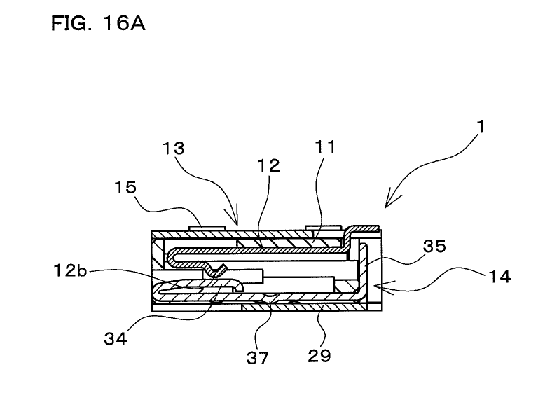

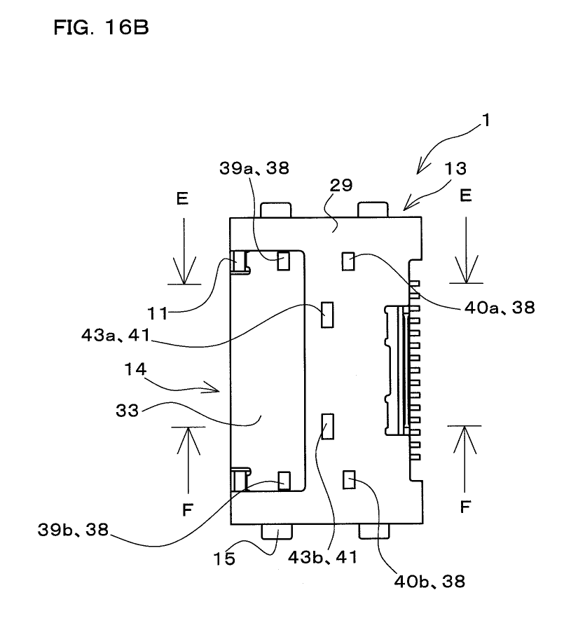

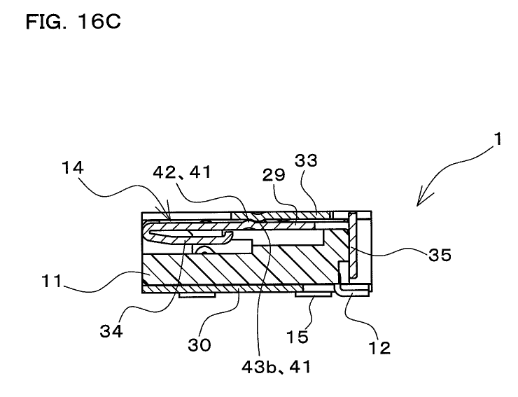

The protrusions 37 are provided as portions formed protruding in a raised manner at the flat portion 33 toward the upper side (for example, bulged portions formed protruding in a substantially spherical shape or in the shape of a projection), and can be formed, for example, by press working. In this embodiment, the protrusions 37 are provided in pair, and are respectively disposed on opposite sides of the slider 14 in the width direction. The slider 14 and the shell 13 are configured to be electrically connected by coming into contact with each other via the protrusions 37. In other words, the protrusions 37 provided on the flat portion 33 of the slider 14 and the inner side of the coupling shield wall 29 of the shell 13 are configured to be electrically connected. Note that the slider 14 is attached to the housing 11 so as to be electrically connected to the shell 13 via protrusions 37, both in states before and after moving from the rear side to the front side with respect to the housing 11 (see FIG. 9, and FIGS. 15 and 16, which will be described later).

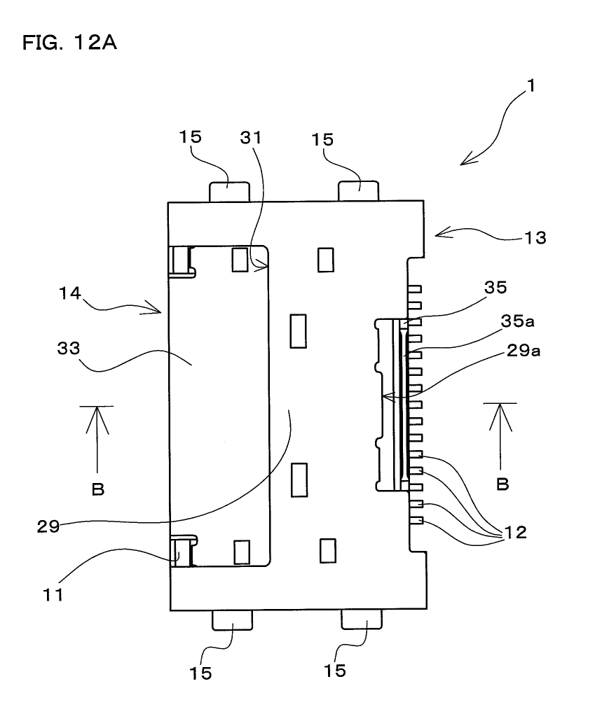

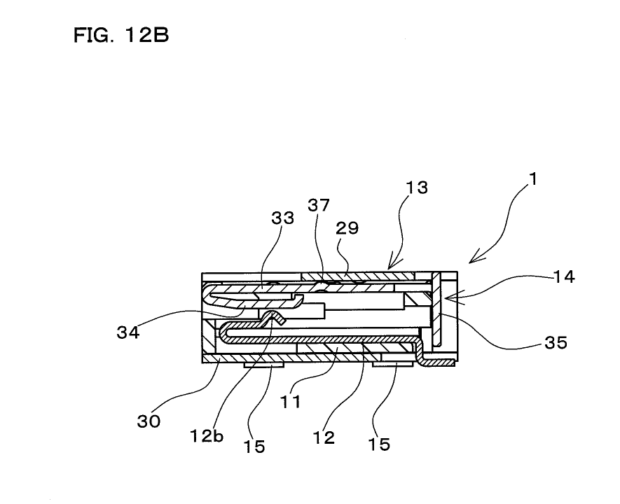

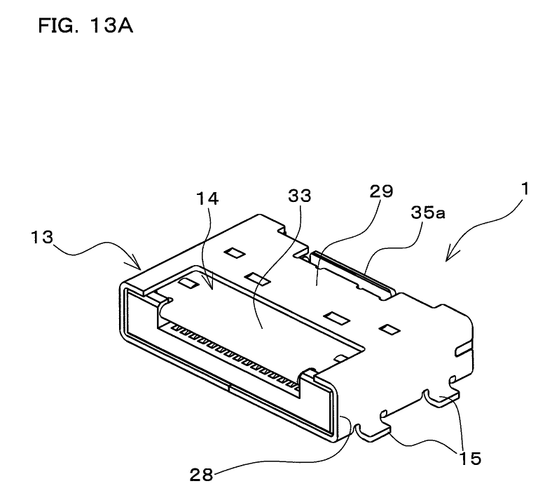

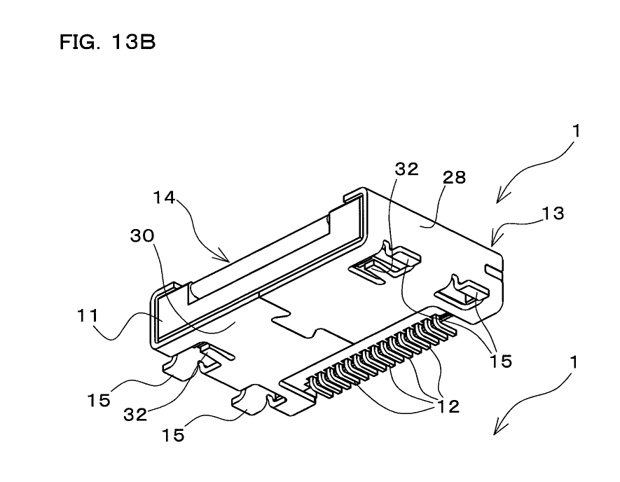

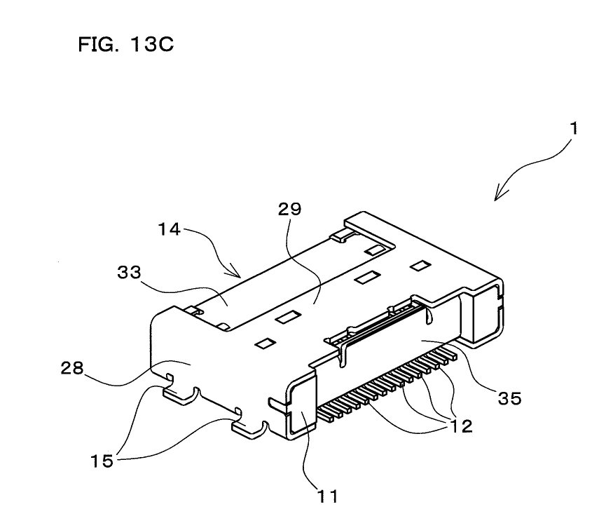

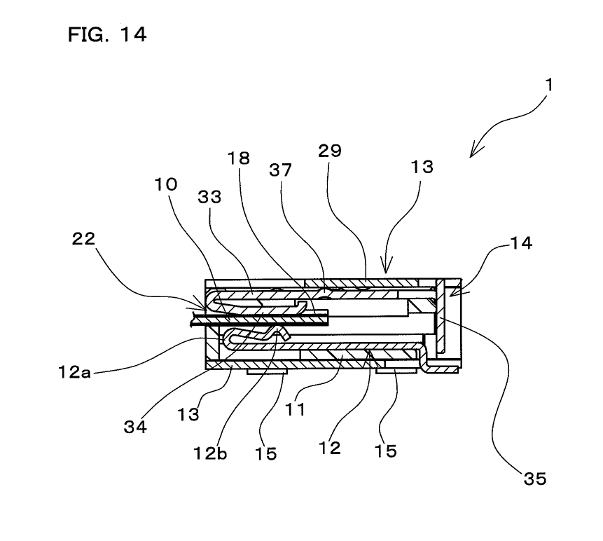

FIG. 12A is a plan view showing a state where the slider 14 has moved to the front side with respect to the housing 11 in the shield connector 1, FIG. 12B is a cross-sectional view showing a cross section at the position of the arrows B-B in FIG. 12A. FIG. 13 is a perspective view of the shield connector 1 in a state shown in FIG. 12. FIGS. 13A, 13B and 13C are perspective views of the shield connector 1 as viewed from different angles. FIG. 14 is a cross-sectional view showing a cross section of the flexible conductive member 10 and the shield connector 1 in a state where the connection operation between the flexible conductive member 10 and the shield connector 1 has been performed, thus completing electrical connection and mechanical connection. FIG. 14 is a cross-sectional view of the flexible conductive member 10 and the shield connector 1 in the state shown in FIG. 4, showing a cross-sectional view taken at the cross section corresponding to the position of the arrows B-B in FIG. 12A. FIGS. 12 and 13 show a state where the slider 14 has moved to the front side when the flexible conductive member 10 is not disposed in the housing 11, and shown as reference drawings for more clearly illustrating the positional relationship when the slider 14 has moved with respect to the housing 11.

By the operating portion 35a of the slider 14 being operated by the operator so as to be pushed in toward the shell 13, the slider 14 moves from the rear side toward the front side with respect to the housing 11 (see FIGS. 12 to 14). When performing the connection operation between the flexible conductive member 10 and the shield connector 1, first, the flexible conductive member 10 is disposed in the open portion 22 of the housing 11. Then, the operation for pushing the operating portion 35a is performed as described above and the slider 14 is thus brought into a state where it has moved from the rear side to the front side with respect to the housing 11, as a result of which the shield connection portion 34 of the slider 14 presses the end of the flexible conductive member 10 disposed above the plurality of contacts 12 toward the plurality of contacts 12.

Due to the foregoing, the contact portions 12b of the contacts 12 and the conductors 16 of the flexible conductive member 10 are electrically connected, and the shield connection portion 34 of the slider 14 and the shield portion 18 exposed on the surface of the flexible conductive member 10 are electrically connected, as shown in FIG. 14. Further, the constant electrical connection between the slider 14 and the shell 13 via the protrusions 37 can be maintained in both states before and after the slider 14 moves from the rear side to the front side with respect to the housing 11. Additionally, when electrically connecting the contact portions 12b of the contacts 12 and the conductors 16 of the flexible conductive member 10 in the above-described manner, the contact portions 12b and the conductors 16 are brought into contact by being strongly pressed by the elastic force of the shield connection portion 34 and the elastic force of the spring portions 12a, thus ensuring a reliable electrical connection.

The slider 14 is configured to cover the open portion 22 of the housing 11 by moving from the rear side toward the front side with respect to the housing 11, and also to cover the open portion 22 so as to extend beyond portions of contact between the contacts 12 and the conductors 16 of the flexible conductive member 10 from the rear side toward the front side (see FIGS. 4 and 14). Furthermore, in a state where the slider 14 has moved to the front side of the housing 11 and thus covers the open portion 22, the slider 14 is positioned so as to close the shell-side open portion 31 from below.

An indentation 29a that is recessed is formed in a central part at an upper end on the rear side of the shell 13. In a state where the slider 14 has moved to the front side and thus the connector connection operation is finished, the operating portion 35a of the slider 14 is disposed in the indentation 29a. This enables compact storage of the slider 14 in the shell 13.

Here, a description is given of a configuration that causes the slider 14 to come into locking engagement with the shell 13 in states before and after the slider 14 is moved toward the front side with respect to the housing 11. FIG. 15 are diagrams showing a plan view (FIG. 15B) of the shield connector 1 in the state shown in FIG. 1A (the state where the flexible conductive member 10 is not disposed in the housing 11 and the operation for moving the slider 14 to the front side has not been performed), and a cross-sectional view (FIG. 15A) taken at the position of the arrows C-C in FIG. 15B, a cross-sectional view (FIG. 15C) taken at the position of the arrows D-D in FIG. 15B. Note that in FIG. 15, FIG. 15A corresponds to the direction of the arrows C-C in FIG. 15B, and therefore the shield connector 1 is shown upside-down.

As shown in FIGS. 10, 11, and 15, the slider 14 and the shell 13 are provided with first locking portions 38 that are formed as raised portions coming into locking engagement with each other in a state before the slider 14 moves from the rear side toward the front side with respect to the housing 11 (even if the end of the flexible conductive member 10 is disposed in the housing 11, a state before performing the connector connection operation). The first locking portions 38 are made up of slider-side first locking portions (39a, 39b) provided in the slider 14 and shell-side first locking portions (40a, 40b) provided in the shell 13.

The slider-side first locking portions (39a, 39b) are provided on the flat portion 33, protrude upward, and are formed as short raised portions protruding with a circular-arc cross section and extending along the width direction of the slider 14. Also, the slider-side first locking portions (39a, 39b) are provided in pair, and are respectively disposed on opposite sides of the slider 14 in the width direction. On the other hand, the shell-side first locking portions (40a, 40b) are provided on the coupling shield wall 29, protrude downward on the bottom surface side of the coupling shield wall 29, and are formed as short raised portions protruding with a circular-arc cross section and extending the width direction of the shell 13. Also, the shell-side first locking portions (40a, 40b) are provided in pair, and are respectively disposed on opposite sides of the shell 13 in the width direction. Note that FIGS. 10 and 15B show the back side of the shell-side first locking portions (40a, 40b). The slider-side first locking portions (39a, 39b) and the shell-side first locking portions (40a, 40b) may be formed, for example, by press working.

FIG. 15 show the state before the slider-side first locking portions (39a, 39b) and the shell-side first locking portions (40a, 40b) come into locking engagement. From this state, by performing an operation for slightly pushing the slider 14 toward the front side, the slider-side first locking portions (39a, 39b) move so as to climb over the shell-side first locking portions (40a, 40b), thus bringing the slider-side first locking portions (39a, 39b) and the shell-side first locking portions (40a, 40b) into locking engagement with each other. When the operator performs the operation for causing the slider-side first locking portions (39a, 39b) to move so as to climb over the shell-side first locking portions (40a, 40b), thus bringing the slider 14 and the shell 13 into locking engagement in the first locking portions 38, the operator can feel a click resulting from that operation. That is, the operator can feel a click, or the feeling of vibrations transmitted to the fingers resulting from an instantaneous elastic recovery at the first locking portions 38.

In addition, as shown in FIG. 15A, the state where the protrusions 37 of the slider 14 are in contact with the inner side of the coupling shield wall 29 of the shell 13 is maintained also in a state before the slider 14 moves from the rear side toward the front side with respect to the housing 11. This ensures the electrical connection between the slider 14 and the shell 13.

FIG. 16 are diagrams showing a plan view (FIG. 16B) of the shield connector 1 in the state shown in FIG. 12A (the state where the flexible conductive member 10 is not disposed in the housing 11 and the operation for moving the slider 14 to the front side has been performed), and a cross-sectional view (FIG. 16A) taken at the position of the arrows E-E in FIG. 16B, a cross-sectional view (FIG. 16C) taken at the position of the arrows F-F in FIG. 16B. Note that in FIG. 16, FIG. 16A corresponds to the direction of the arrows E-E in FIG. 16B, and therefore the shield connector 1 is shown upside-down.

As shown in FIGS. 10, 11, and 16, the slider 14 and the shell 13 are provided with second locking portions 41 that are formed as raised portions coming into locking engagement with each other in a state after the slider 14 has moved from the rear side toward the front side with respect to the housing 11 (if the end of the flexible conductive member 10 is disposed in the housing 11, a state after performing the connector connection operation and thus electrical connection has been completed). The second locking portions 41 are made up of a slider-side second locking portion 42 provided in the slider 14 and shell-side second locking portions (43a, 43b) provided in the shell 13.

The slider-side second locking portion 42 is provided on the flat portion 33, protrudes upward, and is formed as a long raised portion protruding with a circular-arc cross section and extending along the width direction of the slider 14. Also, a single slider-side second locking portion 42 is provided, and is disposed across the central part of the slider 14 in the width direction. On the other hand, the shell-side second locking portions (43a, 43b) are provided on the coupling shield wall 29, protrude downward on the bottom surface side of the coupling shield wall 29, and are formed as short raised portions protruding with a circular-arc cross section and extending the width direction of the shell 13. Also, the shell-side second locking portions (43a, 43b) are provided in pair, and are respectively disposed on opposite sides of the shell 13 in the width direction. Note that FIGS. 10 and 16B show the back side of the shell-side first locking portions (40a, 40b). The slider-side second locking portion 42 and the shell-side second locking portions (43a, 43b) may be formed, for example, press working.

FIG. 16 show the state after the slider-side second locking portion 42 and the shell-side second locking portions (43a, 43b) have come into locking engagement. That is, in this state, an operation for moving the slider 14 from the rear side toward the front side with respect to the housing 11 has been performed, and the slider-side second locking portion 42 has moved so as to climb over the shell-side second locking portions (43a, 43b), thus bringing the slider-side second locking portion 42 and the shell-side second locking portions (43a, 43b) into locking engagement with other. When the operator performs the operation for causing the slider-side second locking portion 42 to move so as to climb over the shell-side second locking portions (43a, 43b) in this way, thus bringing the slider 14 and the shell 13 into locking engagement in the second locking portions 41, the operator can feel a click resulting from that operation. That is, the operator can feel a click, or the feeling of vibrations transmitted to the fingers resulting from an instantaneous elastic recovery at the second locking portions 41.

In addition, as shown in FIG. 16A, the state where the protrusions 37 of the slider 14 are in contact with the inner side of the coupling shield wall 29 of the shell 13 is maintained also in a state after the slider 14 has moved from the rear side toward the front side with respect to the housing 11, continuously from the state before the movement. This ensures the electrical connection between the slider 14 and the shell 13.

As described above, with the shield connector 1, an end of the flexible conductive member 10 is disposed in the shield connector 1 that has been assembled in the state shown in FIG. 1 and that has been fixed by soldering to the substrate (not shown) at the lead portions 15. The end of the flexible conductive member 10 is disposed in the open portion 22 of the housing 11. At this time, the end of the flexible conductive member 10 is guided by the guide grooves 23 of the housing 11, and is disposed in an appropriate position of the housing 11.

When the placement of the end of the flexible conductive member 10 in the housing 11 is finished, then the operation for moving the slider 14 is performed. At this time, the slider 14 is operated at the operating portion 35a, and moves from the rear side to the front side with respect to the housing 11. When this movement operation is finished, the slider 14 presses the flexible conductive member 10 toward the contacts 12 side, so that the conductors 16 of the flexible conductive member 10 and the contacts 12 are electrically connected. Also, the slider 14 is electrically connected to the shield portion 18 of the flexible conductive member 10 at the shield connection portion 34. Further, the electrically connected state between the slider 14 and the shell 13 via the protrusions 37, is continuously maintained before and after the movement of the slider 14.

As described thus far, with the shield connector 1, the shell 13 covering the circumference of the housing 11 is electrically connected to the shield portion 18 of the flexible conductive member 10 via the slider 14, and the lead portions 15 formed integrally with the shell 13 are fixed to the ground side of the substrate, thus achieving a shielding function. Also, the shell 13 is provided with the pair of side face shield walls (28, 28) respectively covering both side faces of the housing 11 and the coupling shield wall 29 that is perpendicular to the pair of side face shield walls (28, 28) and that couples the pair of side face shield walls (28, 28) together. Accordingly, a sufficient shielding function as an anti-electromagnetic wave noise measure can be ensured for the both side faces of the housing 11 covered by the shell 13 and surfaces perpendicular thereto.

Furthermore, the shell 13 is also provided with the opposed shield walls 30 disposed so as to be opposed to the coupling shield wall 29, in addition to the pair of side face shield walls (28, 28) and the coupling shield wall 29. Accordingly, it is possible to configure the shell 13 in the form of a rectangular tube, and realize a shell structure that can shield four peripheral surfaces of the housing 11 only by the shell 13. Note that since the shell 13 is configured in the form of a rectangular tube formed of a metallic material, it is possible to ensure the overall geometrical moment of inertia of the shield connector 1 with a compact structure, and improve the strength and the rigidity. Accordingly, the bending deformation of the shield connector 1 at its central part in the width direction can be suppressed efficiently.

With the shield connector 1, the slider 14 moves from the rear side toward the front side with respect to the housing 11, thus electrically connecting the contacts 12 and the conductors 16 of the flexible conductive member 10, and being brought into the state of being electrically connected to the shield portion 18 exposed on the flexible conductive member 10 and to the shell 13. This completes an electrical connection. Accordingly, since the slider 14 is operated to move from the rear side toward the front side with respect to the housing 11, the operating portion 35a of the slider 14 and the flexible conductive member 10 whose end is disposed in the housing 11 are separately positioned on the sides opposite from each other via the housing 11, when performing the connector connection operation for completing an electrical connection between the flexible conductive member 10 and the shield connector 1 after operating the slider 14. This prevents the fingers of the operator and the flexible conductive member 10 from coming into contact to make the operation of the slider 14 difficult, thus improving the operability of the slider 14.

Furthermore, with the shield connector 1, the slider 14 is attached to the housing 11 so as to move from the rear side of the housing 11 toward the front side during operation of the slider 14. Accordingly, it is possible to prevent the slider 14 from blocking the field of view of the operator when inserting an end of the flexible conductive member 10 to the front side of the housing 11. This facilitates the placement of the end of the flexible conductive member 10 in an appropriate position of the housing 11.

Furthermore, with the shield connector 1, the slider 14 is attached to the housing 11 so as to move from the rear side of the housing 11 toward the front side during operation, as described above. Accordingly, when the slider 14 is operated to move, the operator can easily operate the slider 14 at an intermediate part of the slider 14 in the width direction or at the operating portion 35a, which is located near that intermediate part. Accordingly, when the operator performs an operation (operation of pulling out a slider) for moving the slider 14 so as to pull out the slider 14 to the opposite side to the direction of the connector connection operation from the state where an electrical connection has been once completed, it is possible to prevent to a damage to the shield connector as caused in conventional shield connectors. In other words, it is possible to prevent the occurrence of such a condition in which the slider is forcibly pulled out in such a state where the slider pries into the housing and the like due to the operation timings of the plurality of operating portions failing to coincide, thus making it possible to prevent a damage to the shield connector 1 during the operation of pulling out the slider 14.

Therefore, with this embodiment, it is possible to provide a shield connector 1 that can ensure a sufficient shielding function, can improve the operability of the slider 14, can facilitate the placement of the flexible conductive member 10, and can prevent the occurrence of damage during the operation of pulling out the slider 14.

Furthermore, with the shield connector 1, the housing 11 is provided with the open portion 22 that is opened from the front side to the upper side, exposing the plurality of contacts 12. Since an end of the flexible conductive member 10 can be disposed in the open portion 22, which is widely opened in this way, it is possible to realize a shield connector 1 that can further facilitate the placement of the flexible conductive member 10. Further, since the open portion 22, which is a region where the end of the flexible conductive member 10 is disposed, is widely opened from the front side to the upper side in the housing 11, it is possible to select the configuration for inserting the end of the flexible conductive member 10 into the housing 11 from various configurations, and therefore the degree of freedom in design as the shield connector can be greatly improved.

Furthermore, with the shield connector 1, the coupling shield wall 29 of the shell 13 is provided as a wall portion covering the upper side of the housing 11, and the shell-side open portion 31 corresponding to the open portion 22 of the housing 11 is opened in the coupling shield wall 29. Accordingly, during the placement of the end of the flexible conductive member 10 in the open portion 22 of the housing 11, it is possible to prevent the slider 14 from blocking the field of view of the operator, and also to prevent the shell 13 from blocking the field of view of the operator. This can further facilitate the placement of the end of the flexible conductive member 10 in an appropriate position of the housing 11.

Furthermore, with the shield connector 1, the slider 14 moves from the rear side to the front side during the connector connection operation, thereby covering the open portion 22 so as to cover at least the portions of contact between the contacts 12 and the conductors 16 of the flexible conductive member 10. Accordingly, at least a region in the vicinity of the portions of contact between the contacts 12 and the conductors 16 of the flexible conductive member 10 is shielded in the open portion 22 by the slider 14. Thus, when disposing the end of the flexible conductive member 10 in the housing 11, the flexible conductive member 10 can be easily disposed in the open portion 22, and it is also possible to achieve a shield connector 1 that can appropriately shield the open portion 22 by the slider 14 in a state where an electrical connection has been completed.

Furthermore, with the shield connector 1, the slider 14 is configured to be electrically connected to the shell 13 both in states before and after operating the slider 14 for the connector connection operation. Accordingly, the slider 14 is electrically connected to the shell 13 constantly also in a state before the connector connection operation, thus preventing accumulation of static electricity, and further enhancing the shielding function.

Furthermore, with the shield connector 1, the slider 14 is provided with the rear surface wall 35 covering the rear side surface of the housing 11, and therefore it is possible to shield the rear side of the housing 11, and further enhance the shielding function. Further, the rear surface wall 35 is disposed on the side opposite to the front side of the housing 11, which is the side where the end of the flexible conductive member 10 is disposed and the flexible conductive member 10 is drawn out. Accordingly, it is possible to easily install the rear surface wall 35 without affecting the placement of the flexible conductive member 10.

Furthermore, with the shield connector 1, it is possible to easily achieve a structure that can reliably ensure an electrical connection between the slider 14 and the shell 13 for exerting the shielding function with a simple configuration in which the slider 14 is provided with the protrusions 37 that are formed in a raised manner.

Furthermore, with the shield connector 1, the first locking portions 38 and the second locking portions 41 coming into locking engagement in states of before and after operating the slider 14 for the connector connection operation are provided as raised portions in the slider 14 and the shell 13. Accordingly, when the operation for bringing the shell 13 and the slider 14 into locking engagement in the first locking portions 38 is performed, the feeling of a click is generated by that operation, and therefore the operator can easily confirm that the shell 13 has come into locking engagement with the slider 14 in a state before the connector connection operation. When the operation for bringing the shell 13 and the slider 14 into locking engagement in the second locking portions 41 is performed, the feeling of a click is generated by that operation, and therefore the operator can easily confirm that the connector connection operation has been completed.

Furthermore, with the shield connector 1, when an end of the flexible conductive member 10 is inserted into the housing 11, the end of the flexible conductive member 10 is guided to a predetermined position along the guide grooves 23 formed in the housing 11. This can further facilitate the placement of the flexible conductive member 10 in an appropriate position relative to the housing 11.

Furthermore, with the shield connector 1, the end of the flexible conductive member 10 that can be disposed in the housing 11 is provided with the projecting piece portions (20a, 20b) that protrude to both lateral sides on opposite sides in the width direction. When the end of the flexible conductive member 10 is inserted into the housing 11, the end of the flexible conductive member 10 is guided to a predetermined position by the projecting piece portions (20a, 20b) along the guide grooves 23 of the housing 11. Further, upon reaching an appropriate position of the housing 11, the end of the flexible conductive member 10 engages with the housing 11 in the projecting piece portions (20a, 20b) toward the front side. Accordingly, if the slider 14 is operated to move from the rear side toward the front side in a state where the end of the flexible conductive member 10 is disposed in the housing 11, it is possible to prevent the flexible conductive member 10 from being detached from the housing 11 to the front side due to a frictional force exerted from the slider 14.

Although an embodiment of the present invention has been described thus far, all modifications, applications and equivalents thereof that fall within the claims, for which modifications and applications would become apparent by reading and understanding the present specification, are intended to be embraced therein. For example, the following modifications are possible.

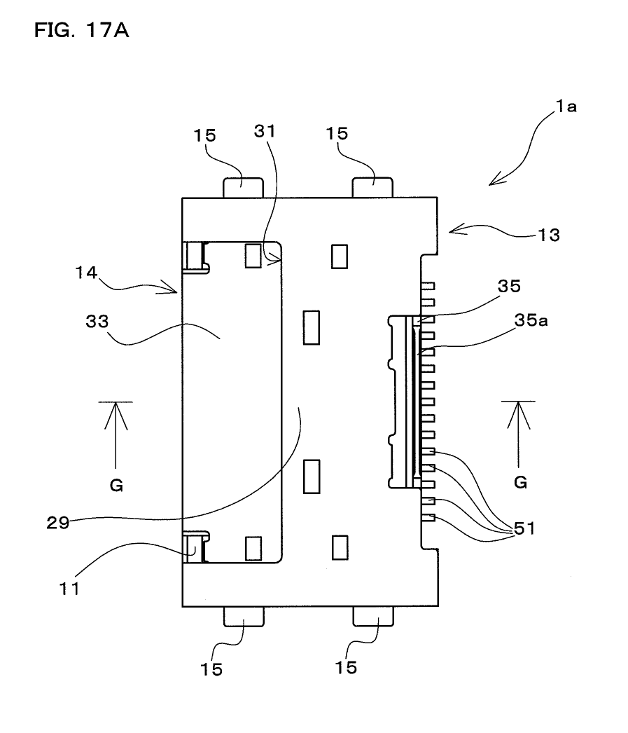

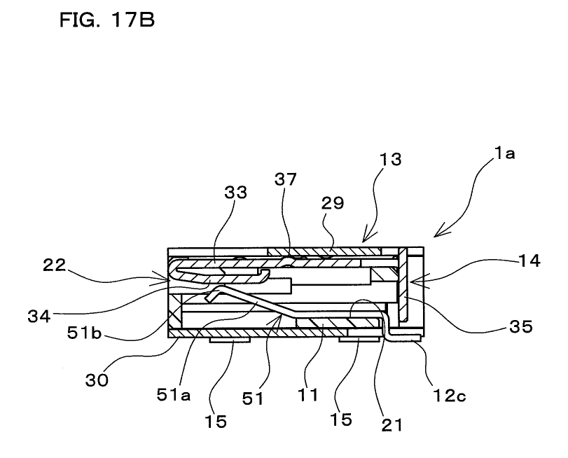

(1) Although the above embodiment has been described taking, as an example, a configuration in which the shell includes a pair of side face shield walls, a coupling shield wall, and opposed shield walls and is formed in the shape of a rectangular tube, this need not be the case. It is possible to adopt a configuration in which the shell includes a pair of side face shield wall and a coupling shield wall, but does not include opposed shield walls. In this case, the coupling shield wall may be disposed on the top face side of the housing, and the shielding function for the bottom face side of the housing may be ensured by the ground side of the substrate.
(2) Although the above embodiment has been described taking, as an example, a configuration in which the slider is movably attached to the housing while coming into slidable contact therewith, this need not be the case. It is possible to adopt any configuration in which the slider is movably attached to at least one of the housing and the shell while coming into slidable contact therewith. That is, it is possible to adopt a configuration in which the slider is movably attached to the shell while coming into slidable contact therewith, or a configuration in which the slider is movably attached to both the housing and the shell while coming into slidable contact therewith in an alternating manner.
(3) Although the above embodiment has been described taking, as an example, a configuration in which the rear surface wall is formed in the slider, this need not be the case. It is possible to adopt any configuration in which the rear surface wall is formed in at least one of the shell and the slider. That is, it is possible to adopt a configuration in which the rear surface wall is formed in the shell, or a configuration in which the rear surface wall is formed in both the shell and the slider.
(4) Although the above embodiment has been described taking, as an example, a configuration in which the protrusions for ensuring the electrical connection between the slider and the shell are provided in the slider, this need not be the case. It is possible to adopt any configuration in which the above-described protrusions are provided in at least one of the slider and the shell. That is, it is possible to adopt a configuration in which the protrusions are provided in the shell, or a configuration in which the protrusions are provided in both the shell and the slider.
(5) The configurations of the open portion, the shell-side open portion, the first locking portions, and the second locking portions are not limited to the configurations illustrated in the above embodiment, and various modifications can be made for the shape and the arrangement.
(6) The shapes of the contacts and the slider are not limited to those illustrated in the above-described embodiment, and various modifications may be made. For example, modifications as shown in FIGS. 17 to 20 may be implemented.

FIG. 17 are diagrams showing a plan view (FIG. 17A) showing a shield connector 1a according to a modification, and a cross-sectional view (FIG. 17B) taken at the position of the arrows G-G in FIG. 17A. Note that FIG. 17 are shown as diagrams corresponding to the state shown in FIG. 12 in the above embodiment (the state where the slider 14 has moved to the front side of the housing 11 when the flexible conductive member 10 is not disposed). The shield connector 1a according to the modification shown in FIG. 17 is configured in the same manner as the shield connector 1 according to the above embodiment, and includes the housing 11, the shell 13, the slider 14, and a plurality of contacts 51. However, the contacts 51 of the shield connector 1a are different in structure from the contacts 12 of the shield connector 1. Note that in the description of the shield connector 1a according to the modification in FIG. 17, the description of those components configured in the same manner as in the shield connector 1 is omitted by using the same reference numerals in the drawings, or by referring to the same reference numerals.

As shown in FIG. 17, the contacts 51 of the shield connector 1a according to a modification are each provided with a spring portion 51a, a contact portion 51b, a connection portion 12c configured in the same manner as the connection portion 12c of the contacts 12, and so forth.

The spring portion 51a is formed as a portion extending in a cantilevered manner so as to form an obtuse angle with respect to the portion of the contact 51 that is supported in the contact support groove 21 of the housing 11, and is provided as a portion having flexibility by elastic deformation. The elastic force exerted by the spring portion 51a causes the contact portion 51b to be pushed against the conductor 16 of the flexible conductive member 10. Note that since the spring portion 51a is formed as a portion extending so as to form an obtuse angle with respect to the portion of the contact 51 that is supported in the contact support groove 21, the spring length can easily be set to be long in a compact space, thus making it possible to easily realize a structure that can easily ensure elastic force and increase the degree of freedom of the design for setting the elastic force. Moreover, it is possible to realize a reduction in the thickness of the shield connector 1a.

The contact portion 51b is formed as a portion that is bent to have a triangular cross section at the tip end portion of each of the contacts 51 and that protrudes upward at the vertex portion of the triangular cross section, and is provided as a portion that can be electrically connected to each of the conductors 16 of the flexible conductive member 10. Note that the contact portions 51b are disposed protruding from the contact support grooves 21 to the upper side such that they can be connected to the conductors 16 at the end of the flexible conductive member 10 disposed in the open portion 22.

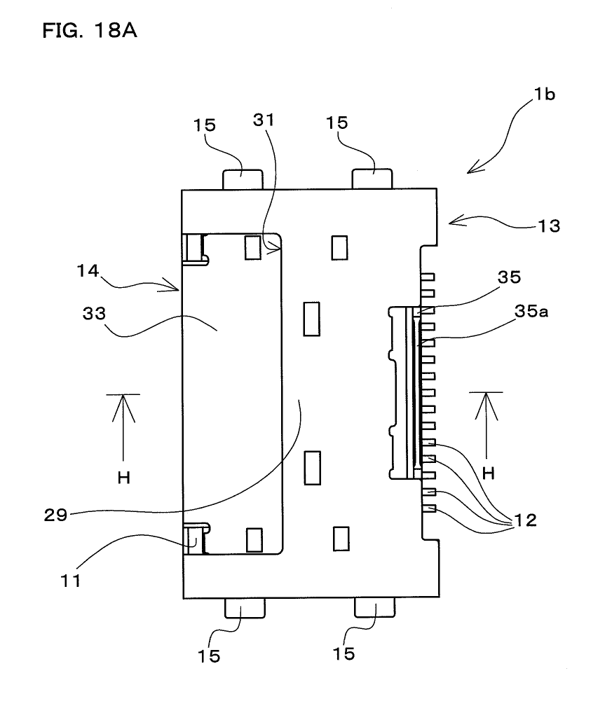

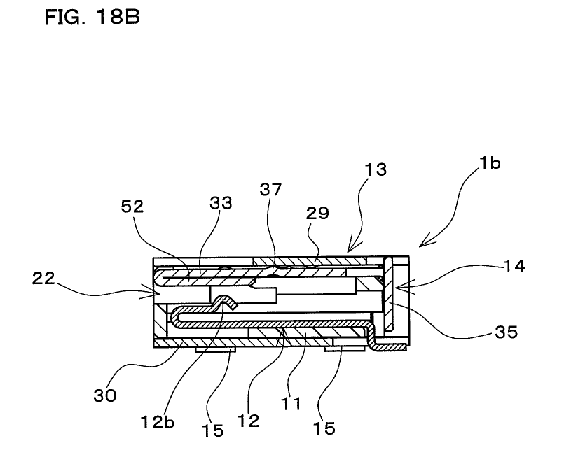

FIG. 18 are diagrams showing a plan view (FIG. 18A) showing a shield connector 1b according to a modification, and a cross-sectional view (FIG. 18B) taken at the position of the arrows H-H in FIG. 18A. Note that FIG. 18 are shown as diagrams corresponding to the state shown in FIG. 12 in the above embodiment (the state where the slider 14 has moved to the front side of the housing 11 when the flexible conductive member 10 is not disposed). The shield connector 1b according to the modification shown in FIG. 18 is configured in the same manner as the shield connector 1 according to the above embodiment, and includes the housing 11, the shell 13, the slider 14, and the plurality of contacts 12. However, a shield connection portion 52 of the slider 14 of the shield connector 1b is different in structure from the shield connection portion 34 of the slider 14 of the shield connector 1. Note that in the description of the shield connector 1b according to the modification in FIG. 18, the description of those components configured in the same manner as in the shield connector 1 is omitted by using the same reference numerals in the drawings, or by referring to the same reference numerals.

As shown in FIG. 18, the shield connection portion 52 is provided on the front side of the flat portion 33a as a portion formed by bending a front side portion of the flat portion 33 over about 180 degrees, and is disposed so as to be elongated in the width direction of the slider 14. Further, the shield connection portion 52 is formed such that a distal portion extending away from the bent portion is in close contact with or adjacent to the flat portion 33 and extends substantially parallel to the flat portion 33 toward the rear side.

The shield connection portion 52 is configured to come into contact with the shield portion 18 of the flexible conductive member 10 and to press the flexible conductive member 10 toward the contact portions 12b of the plurality of the contacts 12, in a state where an end of the flexible conductive member 10 is disposed in the housing 11 and the slider 14 has moved from the rear side toward the front side with respect to the housing 11. Accordingly, as in the case of the shield connector 1, the slider 14 of the shield connector 1b is configured to electrically connect the contact portions 12b of the contacts 12 and the conductors 16 of the flexible conductive member 10 and also to be electrically connected to the shield portion 18 exposed on the surface of the flexible conductive member 10, in a state where the slider 14 has moved from the rear side toward the front side with respect to the housing 11.

With the shield connector 1b, the shield connection portion 52 that is bent over approximately 180 degrees with respect to the flat portion 33 and a distal portion extending away from that bent portion is in close contact with or adjacent to the flat portion 33 and extends substantially parallel to the flat portion 33 toward the rear side is provided in the slider 14 as described above. Accordingly, it is possible to reduce the thickness of the shield connector 1b.

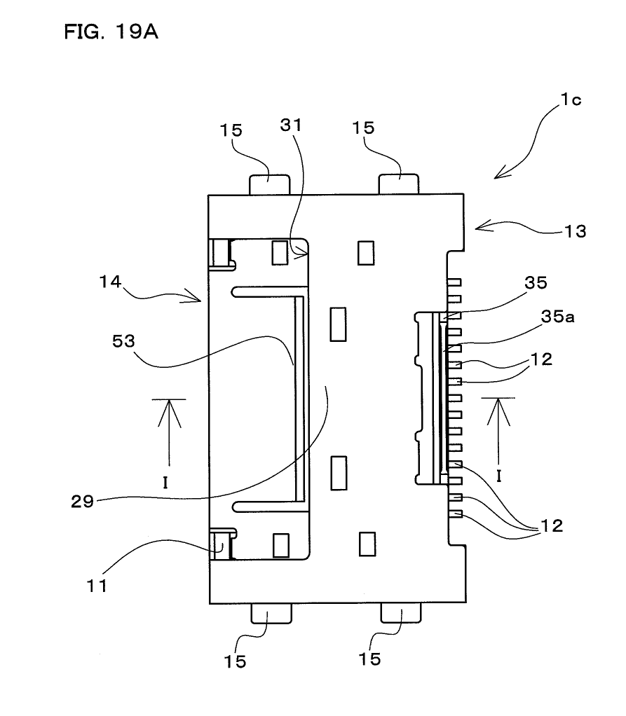

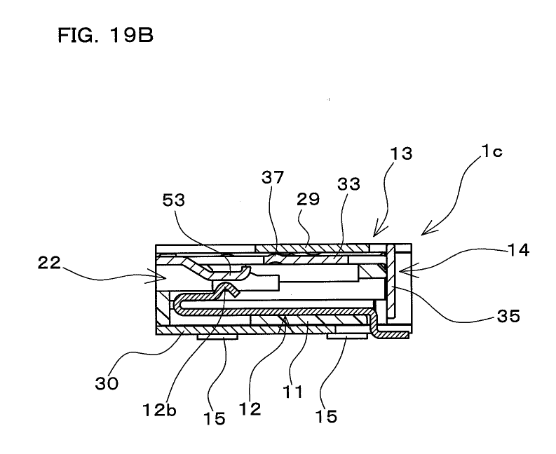

FIG. 19 are diagrams showing a plan view (FIG. 19A) showing a shield connector 1c according to a modification, and a cross-sectional view (FIG. 19B) taken at the position of the arrows I-I in FIG. 19A. Note that FIG. 19 are shown as diagrams corresponding to the state shown in FIG. 12 in the above embodiment (the state where the slider 14 has moved to the front side of the housing 11 when the flexible conductive member 10 is not disposed). The shield connector 1c according to the modification shown in FIG. 19 is configured in the same manner as the shield connector 1 according to the above embodiment, and includes the housing 11, the shell 13, the slider 14, and the plurality of contacts 12. However, a shield connection portion 53 of the slider 14 of the shield connector 1c is different in structure from the shield connection portion 34 of the slider 14 of the shield connector 1. Note that in the description of the shield connector 1c according to the modification in FIG. 19, the description of those components configured in the same manner as in the shield connector 1 is omitted by using the same reference numerals in the drawings, or by referring to the same reference numerals.

As shown in FIG. 19, the shield connection portion 53 is provided on the front side at the central part of the flat portion 33a as a plate-like portion formed by cutting out and bending part of the flat portion 33 so as to protrude toward the rear side in a cantilevered manner, and is disposed so as to be elongated in the width direction of the slider 14. Further, the shield connection portion 53 is formed such that the portion that is supported in a cantilevered manner relative to the flat portion 33 and that is cut out in a cantilevered manner extends obliquely downward to the rear side and then extends substantially parallel to the flat portion 33. Also, the shield connection portion 53 is configured to have flexibility by elastic deformation and to constitute a leaf spring-shaped portion. Note that the tip end portion of the shield connection portion 53 has been processed to be bent in a rounded manner to have a circular-arc cross section in order to prevent it from catching the flexible conductive member 10.

The shield connection portion 53 is configured to come into contact with the shield portion 18 of the flexible conductive member 10 and to press the flexible conductive member 10 toward the contact portions 12b of the plurality of the contacts 12, in a state where an end of the flexible conductive member 10 is disposed in the housing 11 and the slider 14 has moved from the rear side toward the front side with respect to the housing 11. Accordingly, as in the case of the shield connector 1, the slider 14 of the shield connector 1c is configured to electrically connect the contact portions 12b of the contacts 12 and the conductors 16 of the flexible conductive member 10 and also to be electrically connected to the shield portion 18 exposed on the surface of the flexible conductive member 10 in a state where the slider 14 has moved from the rear side toward the front side with respect to the housing 11.

With the shield connector 1c, the shield connection portion 53 of the slider 14 is formed such that the portion that is supported in a cantilevered manner relative to the flat portion 33 and that is cut out in a cantilevered manner extends obliquely downward to the rear side and then extends substantially parallel to the flat portion 33, as described above. Accordingly, the spring length can easily be set to be long in a compact space for the shield connection portion 53, thus making it possible to easily realize a structure that can easily ensure elastic force and increase the degree of freedom of the design for setting the elastic force. Moreover, it is possible to realize a reduction in the thickness of the shield connector 1c.

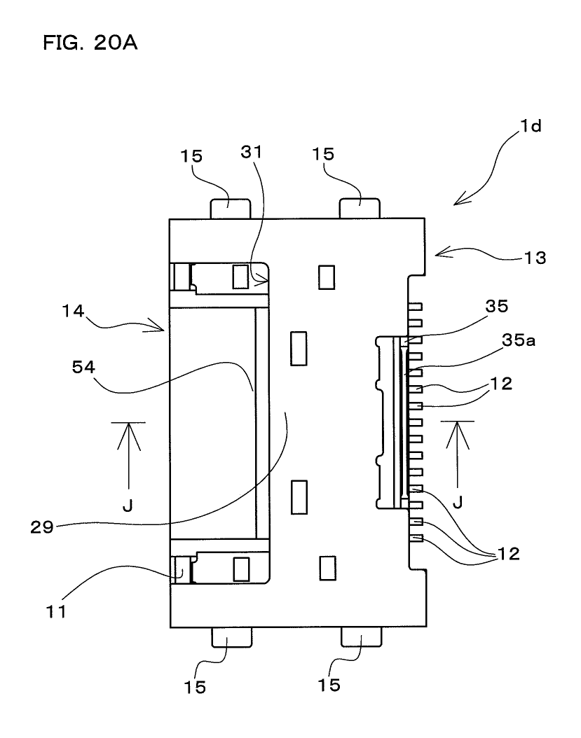

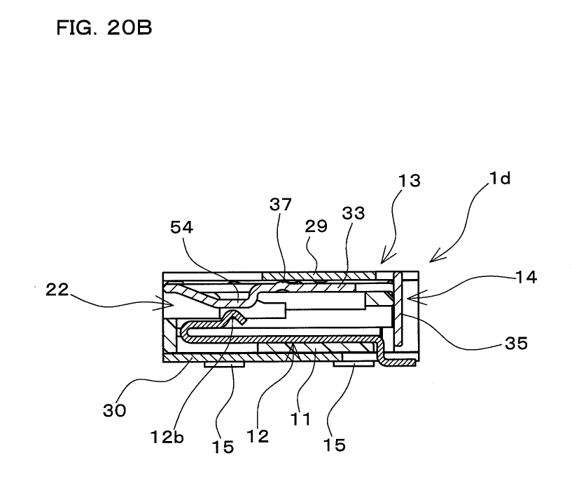

FIG. 20 are diagrams showing a plan view (FIG. 20A) showing a shield connector 1d according to a modification, and a cross-sectional view (FIG. 20B) taken at the position of the arrows J-J in FIG. 20A. Note that FIG. 20 are shown as diagrams corresponding to the state shown in FIG. 12 in the above embodiment (the state where the slider 14 has moved to the front side of the housing 11 when the flexible conductive member 10 is not disposed). The shield connector 1d according to the modification shown in FIG. 20 is configured in the same manner as the shield connector 1 according to the above embodiment, and includes the housing 11, the shell 13, the slider 14, and the plurality of contacts 12. However, a shield connection portion 54 of the slider 14 of the shield connector 1d is different in structure from the shield connection portion 34 of the slider 14 of the shield connector 1. Note that in the description of the shield connector 1d according to the modification in FIG. 20, the description of those components configured in the same manner as in the shield connector 1 is omitted by using the same reference numerals in the drawings, or by referring to the same reference numerals.

As shown in FIG. 20, the shield connection portion 54 is provided on the front side at the central part of the flat portion 33a as a portion formed by bending part of the flat portion 33 so as to protrude toward the lower side, and is disposed so as to be elongated in the width direction of the slider 14. Further, the shield connection portion 54 may be formed, for example, by press working, and is formed in the state of being integrated with the flat portion 33 and recessed downward on the top face side of the flat portion 33 (or in other words, in the state of being bulged downward on the bottom face side of the flat portion 33). Further, a portion that is formed extending substantially parallel to the flat portion 33 is provided in the bottom portion (the portion disposed on the lowest side) of this bent portion formed as the shield connection portion 54.

The shield connection portion 54 is configured to come into contact with the shield portion 18 of the flexible conductive member 10 and to press the flexible conductive member 10 toward the contact portions 12b of the plurality of the contacts 12, in a state where an end of the flexible conductive member 10 is disposed in the housing 11 and the slider 14 has moved from the rear side toward the front side with respect to the housing 11. Accordingly, as in the case of the shield connector 1, the slider 14 of the shield connector 1d is configured to electrically connect the contact portions 12b of the contacts 12 and the conductors 16 of the flexible conductive member 10 and also to be electrically connected to the shield portion 18 exposed on the surface of the flexible conductive member 10 in a state where the slider 14 has moved from the rear side toward the front side with respect to the housing 11.

With the shield connector 1d, the shield connection portion 54 of the slider 14 is formed such that part of the flat portion 33 is bent so as to be in the state of protruding toward the lower side and the bottom portion of the bent portion extends substantially parallel to the flat portion 33, as described above. Accordingly, it is possible to realize a reduction in the thickness of the shield connector 1c.

The present invention can be widely applied as a shield connector that has a shielding function and that can be connected to a flexible conductive member configured as a flexible board or a flexible cable including a plurality of insulated conductors.

What is claimed is:

1. A shield connector comprising:
a housing formed from a resin material;
a plurality of contacts that are supported by the housing and that can be respectively connected to a plurality of insulated conductors of a flexible conductive member configured as a flexible board or a flexible cable;
a shell that is formed of a metallic material, and that includes a pair of side face shield walls for respectively covering both side faces of the housing and a coupling shield wall perpendicular to the pair of side face shield walls and coupling the pair of side face shield walls together, and that is attached to the housing so as to cover a circumference of the housing;
a slider that is formed of a metallic material, that is movably attached to at least one of the housing and the shell while coming into slidable contact therewith, and that is movable between a front side of the housing, which is the side where an end of the flexible conductive member can be disposed, and a rear side, which is opposite to the front side; and
a lead portion that is formed integrally with the shell and that can be fixed by soldering to a substrate configured as at least one of a rigid substrate and a flexible board,
wherein the slider electrically connects the contacts and the conductors of the flexible conductive member and is electrically connected to the shell and a shield portion exposed on the surface of the flexible conductive member, in a state where the slider has moved from the rear side toward the front side with respect to the housing.

2. The shield connector according to claim 1,
wherein the housing is provided with an open portion that is opened such that the end of the flexible conductive member can be disposed therein, and
the open portion is opened in the housing from the front side to an upper side, which is opposite to the side facing the substrate, exposing the plurality of contacts.

3. The shield connector according to claim 2,
wherein the shell is provided, in the coupling shield wall for covering the housing on an upper side, which is opposite to the side where the shell can be installed on the substrate, with a shell-side open portion that is opened, exposing the open portion of the housing.

4. The shield connector according to claim 2,
wherein the slider covers at least part of the open portion by moving from the rear side toward the front side with respect to the housing, and covers the open portion, extending beyond portions of contact between the contacts and the conductors of the flexible conductive member from the rear side toward the front side.

5. The shield connector according to claim 1,
wherein the slider is attached to at least one of the housing and the shell, being electrically connected to the shell also in a state before the slider moves from the rear side toward the front side with respect to the housing.

6. The shield connector according to claim 1,
wherein a rear surface wall is provided that is formed in at least one of the shell and the slider and that can cover a surface of the housing on the rear side.

7. The shield connector according to claim 1,
wherein at least one of the slider and the shell is provided with a protrusion that is formed protruding in a raised manner, and
the slider and the shell are electrically connected via the protrusion.

8. The shield connector according to claim 1,
wherein the slider and the shell are provided with first locking portions formed as raised portions coming into locking engagement with each other in a state before the slider moves from the rear side toward the front side with respect to the housing, and second locking portions formed as raised portions coming into locking engagement with each other in a state after the slider has moved from the rear side toward the front side with respect to the housing.

9. The shield connector according to claim 1,
wherein guide grooves for guiding in a direction in which the end of the flexible conductive member is inserted are formed in the housing.

10. The shield connector according to claim 9,
wherein the end of the flexible conductive member is provided with projecting piece portions that are formed respectively protruding toward both lateral sides in opposite directions in a width direction, which is the direction in which the plurality of conductors are disposed, and that can be inserted into the guide groove, and
the projecting piece portions engage with the housing toward the front side in a state where the end of the flexible conductive member is disposed in the housing.
